(19) United States
(12) Patent Application Publication
(10) Pub. No.: US 2026/0185693 A1
(43) Pub. Date: Jul. 2, 2026

(54) DISHWASHER

(71) Applicant: LG ELECTRONICS INC., Seoul (KR)

(72) Inventors: Kiho JEONG, Seoul (KR); Sang Woo Woo, Seoul (KR); Hoon Kim, Seoul (KR)

(73) Assignee: LG ELECTRONICS INC., Seoul (KR)

(21) Appl. No.: 19/418,138

(22) Filed: Dec. 12, 2025

(30) Foreign Application Priority Data
Dec. 30, 2024 (KR) 10-2024-0199777
Jun. 11, 2025 (KR) 10-2025-0076199

(51) Int. Cl. F21V 33/00; A47L 15/42; A47L 15/50; F21S 8/00; F21V 21/02; F21V 23/06; F21V 31/00; F21Y 105/16; F21Y 115/10

(52) U.S. Cl. CPC F21V 33/0044; A47L 15/4246; F21S 8/036; F21V 21/02; F21V 23/06; F21V 31/005; A47L 15/507; F21Y 2105/16; F21Y 2115/10

(57) ABSTRACT

The present disclosure relates to a dishwasher in which a lighting device is fastened to an inner surface of a tub in a modularized state in which assembly is completed, and thus definition of a through hole having a size corresponding to a light emitting area size as in the prior art is able to be excluded, thereby preventing a decrease in rigidity of the tub and improving a leak-prevention effect.

This non-provisional application claims the benefit under 35 U.S.C. § 119(a) to Korea Patent Application Nos. 10-2024-0199777 and 10-2025-0076199, filed on Dec. 30, 2024 and Jun. 11, 2025, respectively, all of which are hereby expressly incorporated by reference into the present application.

### BACKGROUND

### Field

The present disclosure relates to a dishwasher, and more specifically, to a dishwasher in which a lighting device is fastened to an inner surface of a tub in a modularized state in which assembly is completed, and thus definition of a through hole having a size corresponding to a light emitting area size as in the prior art is able to be excluded, thereby preventing a decrease in rigidity of the tub and improving a leak-prevention effect.

### Description of Related Art

A dishwasher is an apparatus that washes dishes and cooking utensils as washing targets stored therein by spraying washing water thereto. In this regard, the washing water may contain washing detergent.

A dishwasher generally includes a tub having a washing space defined therein, a dish rack that accommodates therein a washing target inside the washing tub, a spraying arm that sprays the washing water into the dish rack, and a sump that stores therein water and supplies the washing water to the spraying arm.

Using this dishwasher may allow a time and effort required to wash the dishes and other washing targets after a meal to be reduced, thereby contributing to user convenience.

Generally, the dishwasher is configured to perform a washing cycle for washing a washing target, a rinsing cycle for rinsing a washing target, and a drying cycle for drying a washing target that has been washed and rinsed.

In order to store dishes inside the dishwasher before the cycle proceeds, and to withdraw the washed and dried dishes after the cycle has been completed, the user should open and close the door.

At least one lighting device may be disposed inside the tub as a means for effectively checking a stored state, a washed state, and the like of the dishes in a situation where the dish rack in which the dishes are accommodated has not been extended to the outside of the tub when the door is opened or closed.

In consideration of a shape of the box-shaped tub having an open front surface, the lighting device may be fixed to one of a rear surface and both side surfaces of the tub constituting inner surfaces of the tub and disposed to irradiate light toward the dishes.

However, the lighting device applied to the existing dishwasher may be formed in a shape of point lighting having a considerably small light emitting area size.

Therefore, in general, it is difficult to effectively illuminate the dishes stored in the tub with only the single lighting device.

In this regard, U.S. Pat. No. 10,281,134 (Prior Document 001) discloses a configuration of a dishwasher having a surface-lighting type lighting device having a light-emitting surface having a light emitting area significantly greater than that of the point-lighting type.

### PRIOR ART DOCUMENTS

### Patent Documents

(Patent Document 001) U.S. Pat. No. 10,281,134

### SUMMARY

A lighting device of a dishwasher disclosed in the prior art document 001 may include a plurality of lighting devices, and each of the lighting devices may be disposed to be fixed to a rear surface of the tub.

In this regard, a light source constituting each lighting device and composed of electric components is fixed to an outer surface of the rear surface of the tub so as not to be affected by a high temperature and high humidity environment formed inside the tub.

A plurality of through holes, each having an open area size corresponding to an area size light-emitting surface, are defined in the rear surface of the tub so as to correspond to the respective lighting devices, such that light generated from the light source may be introduced into the tub.

As described above, a plurality of fasteners extend through the tub and are arranged around the plurality of through holes as a means for fastening components of the lighting device disposed inside the tub and components of the lighting device disposed outside the tub together to the tub.

Accordingly, because fastening holes through which the respective fasteners extend should be defined around the through holes in addition to the through holes having the significantly great open area corresponding to the area size of the light-emitting surface, the dishwasher in the prior art document 001 has a problem in that rigidity of the rear surface of the tub in which the through holes and the fastening holes are defined is significantly deteriorated.

In addition, the dishwasher in the prior document 001 has a problem in that a manufacturing cost and a manufacturing time may be increased resulted from additional processing of the fastening holes in addition to the through holes.

In addition, because a sealing means for preventing leakage of washing water through the fastening hole should be added to each fastening hole, the dishwasher in the prior art document 001 has a problem that the manufacturing cost may be increased and a manufacturing process may be complicated.

The present disclosure has been devised to solve such problems of the prior art, and a first technical purpose thereof is to provide a dishwasher in which a lighting device is fastened to an inner surface of a tub in a modularized state in which assembly is completed, and thus definition of a through hole having a size corresponding to a light emitting area size as in the prior art is able to be excluded, thereby preventing a decrease in rigidity of the tub and improving a leak-prevention effect.

In addition, a second technical purpose of the present disclosure is to provide a dishwasher th allows final fastening of a lighting device to be performed from outside of a tub, but includes a first fastening portion, which guides a position of the lighting device such that a preliminarily-fastened state thereof is maintained at a correct position before the final fastening is performed and prevents the lighting device from deviating, thereby significantly improving assembly efficiency and significantly reducing a manufacturing cost.

In addition, a third technical purpose of the present disclosure is to provide a dishwasher in which a gasket for preventing washing water or foreign substances from entering a lighting module is formed in an overmolding manner at a rear side of the lighting module, thereby improving sealing performance while simplifying a structure and reducing a manufacturing cost.

In addition, a fourth technical purpose of the present disclosure is to provide a dishwasher in which a lower edge of a light-emitting surface of a lighting device extends to a position lower than an upper end of a lower rack, thereby significantly expanding a light emitting area size relative to an area size of a rear wall of a tub compared to prior art, and thus significantly improving visibility of a washing space.

Technical purposes of the present disclosure are not limited to the above-mentioned technical purposes, and other technical purposes and advantages of the present disclosure that are not mentioned may be understood by a following description, and will be more clearly understood by embodiments of the present disclosure. In addition, it will be readily seen that the technical purposes and advantages of the present disclosure may be realized by means indicated in the claims and combinations thereof.

One aspect of the present disclosure provides a dishwasher comprising: a tub defining therein a washing space having an open front surface; and a lighting device having a light-emitting surface for irradiating light toward the washing space, and disposed inside the tub, wherein the lighting device is preliminarily-fastened to an inner surface of the tub using a first fastening portion and then is finally-fastened thereto using a second fastening portion.

In accordance with some embodiments of the dish washer, the lighting device is preliminarily-fastened and finally-fastened to the inner surface of the tub.

In accordance with some embodiments of the dish washer, the first fastening portion includes a connection protrusion protruding rearwards from a rear surface of the lighting device and guiding a fastening position of the lighting device, wherein the tub includes a through hole defined therethrough to allow the connection protrusion to be inserted and coupled thereinto.

In accordance with some embodiments of the dish washer, the connection protrusion includes a first connection protrusion and a second connection protrusion arranged to be spaced apart from each other at different positions, wherein at least one of the first connection protrusion and the second connection protrusion has a passage allowing an inner space of the lighting device and an external space of the tub to be in communication with each other.

In accordance with some embodiments of the dish washer, the lighting device includes: a light source element that generates light; and a circuit board where the light source element and a connector that receives power from an external source are mounted, wherein the connector or a harness electrically connected to the connector is inserted into the passage.

In accordance with some embodiments of the dish washer, the first connection protrusion and the second connection protrusion are arranged at positions spaced apart from each other along an up-down direction on the rear surface of the lighting device.

In accordance with some embodiments of the dish washer, the first connection protrusion and the second connection protrusion are arranged at positions spaced apart from each other along a diagonal direction on the rear surface of the lighting device.

In accordance with some embodiments of the dish washer, the first connection protrusion and the second connection protrusion are arranged at positions asymmetrical to each other in the up-down direction or in a left-right direction.

In accordance with some embodiments of the dish washer, the connection protrusion includes: a body having one end integrally connected to the rear surface of the lighting device and a remaining end extending to the outside of the tub through the through hole; and a protrusion formed to protrude radially outwards from an outer circumferential surface of the remaining end of the body.

In accordance with some embodiments of the dish washer, a maximum outer diameter of the protrusion is greater than or equal to a diameter of the through hole.

In accordance with some embodiments of the dish washer, an outer diameter of the body is smaller than a diameter of the through hole.

In accordance with some embodiments of the dish washer, the first fastening portion further includes a holder disposed outside the tub and coupled to the protrusion in a stopped manner.

In accordance with some embodiments of the dish washer, the holder includes: a hollow allowing the body of the connection protrusion to be inserted and coupled thereinto; and a locking protrusion integrally formed with an inner circumferential surface of the hollow and coupled to the protrusion in the stopped manner, wherein the locking protrusion extends spirally along the inner circumferential surface of the hollow.

In accordance with some embodiments of the dish washer, the second fastening portion includes a plurality of screw bolts extending through the tub from outside toward inside of the tub and screwed to the lighting device, wherein the tub includes a plurality of screw holes defined through the tub such that the plurality of screw bolts extend therethrough, respectively, wherein at least one pair among the plurality of screw holes are arranged at positions asymmetrical to each other in a left-right direction or at positions asymmetrical to each other in an up-down direction.

In accordance with some embodiments of the dish washer, the lighting device includes a gasket sealing a space between the rear surface of the lighting device and the inner surface of the tub.

In accordance with some embodiments of the dish washer, the gasket is formed by molding an elastic material having a predetermined elasticity onto an outer surface of the lighting device.

In accordance with some embodiments of the dish washer, the dishwasher further comprises a dish rack that stores dishes therein, and includes a plurality of racks disposed in the washing space so as to be extendable and retractable, wherein a lower edge of the light-emitting surface is positioned lower than an upper end of a lower rack positioned at a lowest position among the plurality of racks.

In accordance with some embodiments of the dish washer, an upper edge of the light-emitting surface is positioned higher than an upper end of an upper rack positioned above the lower rack among the plurality of racks.

In accordance with some embodiments of the dish washer, a bumper disposed to protrude rearwards from a rear end of the lower rack is formed on a rear side of the lower rack, wherein a protrusion height of the bumper from the rear end of the lower rack is greater than a protrusion height of the lighting device from the inner surface of the tub.

In accordance with some embodiments of the dish washer, the bumper is positioned lower than the lighting device.

The dishwasher according to the present disclosure is configured such that the lighting device is fastened to the inner surface of the tub in the modularized state in which the assembly is completed, and thus the definition of the through hole having the size corresponding to the light emitting area size as in the prior art is able to be excluded, thereby preventing the decrease in the rigidity of the tub and improving the leak-prevention effect.

In addition, the dishwasher according to the present disclosure allows the final fastening of the lighting device to be performed from outside of the tub, but includes the first fastening portion, which guides the position of the lighting device such that the preliminarily-fastened state thereof is maintained at the correct position before the final fastening is performed and prevents the lighting device from deviating, thereby significantly improving the assembly efficiency and significantly reducing the manufacturing cost.

In addition, the dishwasher according to the present disclosure is configured such that the gasket for preventing washing water or the foreign substances from entering the lighting module is formed in the overmolding manner at the rear side of the lighting module, thereby improving the sealing performance while simplifying the structure and reducing the manufacturing cost.

In addition, the dishwasher according to the present disclosure is configured such that the lower edge of the light-emitting surface of the lighting device extends to the position lower than the upper end of the lower rack, thereby significantly expanding the light emitting area size relative to the area size of the rear wall of the tub compared to prior art, and thus significantly improving the visibility of the washing space.

In addition to the above-described effects, specific effects of the present disclosure will be described together while describing specific matters for implementing the present disclosure hereinafter.

### BRIEF DESCRIPTION OF DRAWINGS

FIG. 1 is a front perspective view of a dishwasher according to an embodiment of the present disclosure.

FIG. 2 is a schematic cross-sectional view of a dishwasher shown in FIG. 1.

FIG. 3 is a front perspective view showing a state in which a door of a dishwasher shown FIG. 1 is opened.

FIGS. 4 and 5 are a front perspective view and a front view showing a state in which a lighting device is disposed on a rear surface of a tub according to an embodiment of the present disclosure.

FIGS. 6 and 7 are a partially enlarged view and a horizontal cross-sectional view of a lower rack and a lighting device viewed from inside of a tub to illustrate a positional relationship between the lighting device and the lower rack shown in FIG. 5.

FIG. 8 shows a front view and a rear view of a lighting device according to an embodiment of the present disclosure.

FIG. 9 is an exploded perspective view of a lighting device shown in FIG. 8.

FIG. 10 shows a perspective view and a partially enlarged view of a light source shown in FIG. 9.

FIG. 11 is a cross-sectional view showing a state in which a lighting device according to an embodiment of the present disclosure is preliminarily-fastened using a first fastening portion.

FIG. 12 is a front perspective view showing a state in which a position at which a lighting device according to an embodiment of the present disclosure is to be fastened to an inner surface of a rear wall of a tub is guided.

FIG. 13 is a rear perspective view for showing a process in which a lighting device shown FIG. 12 is preliminarily-fastened to and finally-fastened to a rear wall of a tub.

FIGS. 14 and 15 are partially enlarged views of FIG. 13.

FIG. 16 is a vertical cross-sectional view showing a state in which a lighting device shown in FIG. 12 is preliminarily-fastened to a rear wall of a tub through a first fastening portion.

FIG. 17 is a vertical cross-sectional view showing a state in which a lighting device shown FIG. 12 is finally-fastened to a rear wall of a tub through a second fastening portion.

FIGS. 18 and 19 are horizontal cross-sectional views showing a state in which a lighting device is coupled to a lighting device-mounted formed area defined in a rear wall of a tub according to a first embodiment of the present disclosure.

FIG. 20 is a horizontal cross-sectional view showing a state in which a lighting device is coupled to a lighting device-mounted formed area defined in a rear wall of a tub according to a second embodiment of the present disclosure.

### DETAILED DESCRIPTIONS

The above-mentioned purpose, features and advantages are described in detail below with reference to the attached drawings. Accordingly, a person skilled in the art in the technical field to which the present disclosure belongs will be able to easily implement the technical idea of the present disclosure. In describing the present disclosure, when it is determined that a detailed description of the known technology related to the present disclosure may unnecessarily obscure the gist of the present disclosure, the detailed description thereof is omitted. Hereinafter, preferred embodiments according to the present disclosure will be described in detail with reference to the attached drawings. In the drawings, identical reference numerals are used to indicate identical or similar components.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise.

It will also be understood that when a first element or layer is referred to as being present “on” a second element or layer, the first element may be disposed directly on the second element or may be disposed indirectly on the second element with a third element or layer being disposed between the first and second elements or layers. It will also be understood that when a first element or layer is referred to as being present “under” a second element or layer, the first element may be disposed directly under the second element or may be disposed indirectly under the second element with a third element or layer being disposed between the first and second elements or layers.

It will be understood that when an element or layer is referred to as being “connected to”, or “coupled to” another element or layer, it may be directly connected to or coupled to another element or layer, or one or more intervening elements or layers therebetween may be present. In addition, it will also be understood that when an element or layer is referred to as being “between” two elements or layers, it may be the only element or layer between the two elements or layers, or one or more intervening elements or layers therebetween may also be present.

It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

Spatially relative terms, such as “beneath,” “below,” “lower,” “under,” “above,” “upper,” and the like, may be used herein for ease of explanation to describe one element or feature's relationship to another element or feature as illustrated in the figures. It will be understood that the spatially relative terms are intended to encompass different orientations of the device in use or in operation, in addition to the orientation depicted in the figures. For example, when the device in the drawings may be turned over, elements described as “below” or “beneath” or “under” other elements or features would then be oriented “above” the other elements or features. Thus, the example terms “below” and “under” may encompass both an orientation of above and below. The device may be otherwise oriented for example, rotated 90 degrees or at other orientations, and the spatially relative descriptors used herein should be interpreted accordingly.

As used herein, “A and/or B” means A, B or A and B, unless specifically stated otherwise. Expression such as “at least one of” when preceding a list of elements may modify the entirety of list of elements and may not modify the individual elements of the list. As used herein, “C to D” means C inclusive to D inclusive unless otherwise specified.

Hereinafter, the present disclosure will be described with reference to drawings showing a configuration according to an embodiment of the present disclosure.

### Overall Structure of Dishwasher

Hereinafter, an overall structure of a dishwasher 1 according to an embodiment of the present disclosure will be described in detail with reference to the attached drawings.

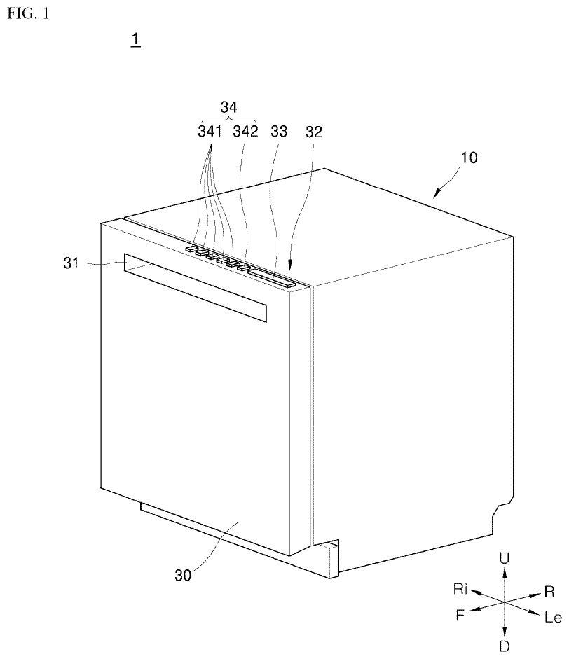

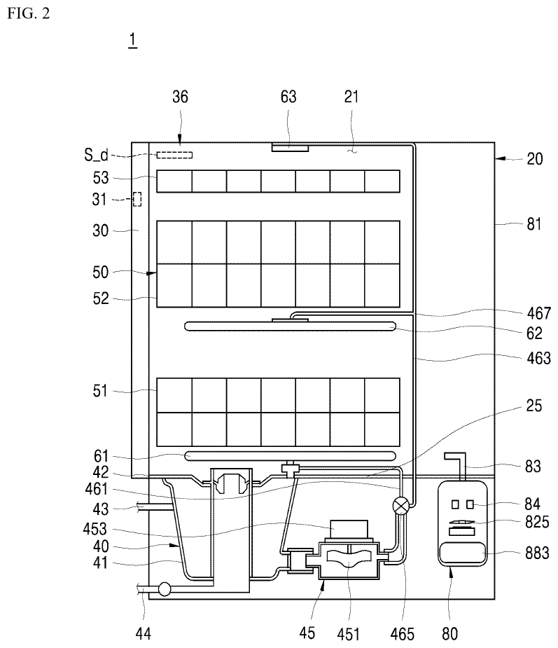

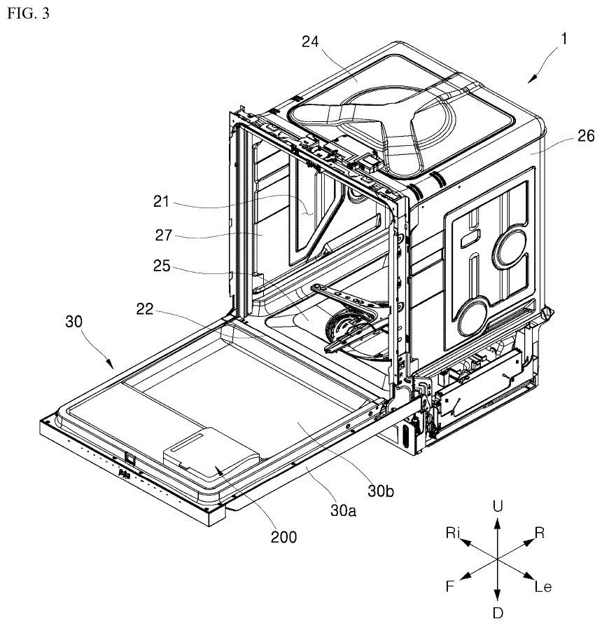

FIG. 1 is a front perspective view showing the dishwasher 1 according to the present disclosure. FIG. 2 is a simplified cross-sectional view briefly showing an internal structure of the dishwasher 1 according to the present disclosure. FIG. 3 is a front perspective view showing the dishwasher 1 in a state in which a door 30 is opened.

As shown in FIG. 1 to FIG. 3, the dishwasher 1 according to the present disclosure may include a casing 10 that constitutes an exterior appearance.

In addition, the dishwasher 1 according to the present disclosure may include a tub 20 installed in an inner space of the casing 10 and having a washing space 21 defined therein where the washing target is washed, wherein a front surface of the tub is open.

In addition, the dishwasher 1 according to the present disclosure may include a door 30 that opens/closes the open front surface of the tub 20.

In addition, the dishwasher 1 according to the present disclosure may include a driver 40 located under the tub 20 to supply, collect, circulate, and discharge the washing water for washing the washing target.

In addition, the dishwasher 1 according to the present disclosure may include a dish rack 50 removably provided in the inner washing space 21 of the tub 20 to receive therein the washing target.

In addition, the dishwasher 1 according to the present disclosure may include a water sprayer installed adjacent to the dish rack 50 to spray the washing water for washing the washing target thereto.

In this regard, the washing target received in the dish rack 50 may be, for example, dishes such as bowls, plates, spoons, and chopsticks, and other cooking utensils. Hereinafter, unless otherwise specified, the washing target will be referred to as a dish.

First, the tub 20 may be formed in a box shape with an entirely open front surface, and have a configuration of a so-referred to as washing tub.

The washing space 21 may be defined inside the tub 20. The open front surface of the tub 20 may be opened/closing by the door 30.

The tub 20 may be formed via pressing of a metal plate resistant to high temperature and moisture, for example, a stainless steel plate.

Moreover, on an inner surface of the tub 20, a plurality of brackets may be disposed for the purpose of supporting and installing functional components such as the dish rack 50 and the water sprayer which will be described later thereon within the tub 20.

In one example, the driver 40 may include a sump 41 that stores therein washing water, a sump cover 42 that distinguishes the sump 41 from the tub 20, a water supply 43 that supplies washing water from an external source to the sump 41, a water discharger 44 that discharges the washing water of the sump 41 to an outside, and a washing pump 45 and a supply flow path 46 that supply the washing water of the sump 41 to the water sprayer.

The sump cover 42 may be disposed at a top of the sump 41 and may serve to distinguish the tub 20 and the sump 41 from each other.

Moreover, the sump cover 42 may have a plurality of collecting holes defined therein for collecting washing water sprayed into the washing space 21 through the water sprayer into the sump 41.

That is, the washing water sprayed from the water sprayer toward the dish may fall down to a bottom of the washing space 21, and may be collected again through the sump cover 42 and into the sump 41.

The washing pump 45 may be disposed at one side of the sump 41 and may serve to pressurize the washing water and supply the pressurized washing water to the water sprayer.

One end of the washing pump 45 may be connected to the sump 41 and the other end thereof may be connected to the supply flow path 46.

The washing pump 45 may be equipped with an impeller 451 and a motor 453. When power is supplied to the motor 453, the impeller 451 may rotate, and thus the washing water in the sump 41 may be pressurized, and then may be supplied to the water sprayer through the supply flow path 46.

Although not shown, a wash water heater may be provided in the washing pump 45 to heat the wash water supplied during a wash cycle or a heat rinse cycle.

In one example, the supply flow path 46 may serve to selectively supply the washing water supplied from the washing pump 45 to the water sprayer.

For example, the supply flow path 46 may include a first supply flow path 461 connected to a lower spraying arm 61, and a second supply flow path 463 connected to an upper spraying arm 62 and a top nozzle 63.

The supply flow path 46 may be provided with a supply flow path switching valve 465 that selectively opens/closes the supply flow paths 461 and 463.

In this regard, the supply flow path switching valve 465 may be controlled so that the supply flow paths 461 and 463 are opened sequentially or simultaneously.

In one example, the water sprayer may be constructed to spray the washing water to the dishes stored in the dish rack 50.

More specifically, the water sprayer may include the lower spraying arm 61 located under the tub 20 to spray the washing water to a lower rack 51.

Further, the water sprayer may include the upper spraying arm 62 located between the lower rack 51 and an upper rack 52 to spray the washing water to the lower rack 51 and the upper rack 52.

Further, the water sprayer may include the top nozzle 63 located on top of the tub 20 to spray the washing water to a top rack 53 or the upper rack 52.

In particular, the lower spraying arm 61 and the upper spraying arm 62 may be rotatably disposed in the washing space 21 of the tub 20 and may spray the washing water toward the dish of the dish rack 50 while being rotating.

The lower spraying arm 61 may be rotatably supported on a top of the sump cover 42 so as to spray the washing water toward the lower rack 51 while being rotating and being disposed under the lower rack 51.

Moreover, the upper spraying arm 62 may be rotatably supported by a spraying arm holder 467 so as to spray the washing water on the dish while being rotating and being disposed between the lower rack 51 and the upper rack 52.

In one example, although not shown, in order to increase washing efficiency, additional means for diverting the washing water sprayed from the lower spraying arm 61 into an upward direction (diverting in a U-direction) may be provided at a lower wall 25 of the tub 20.

A detailed configuration of the water sprayer has been already known in the art. Thus, a description of the specific configuration of the water sprayer will be omitted below.

The dish rack 50 for storing the dish therein may be disposed in the washing space 21.

The dish rack 50 may be constructed to extend or retract from or into the inner space of the tub 20 through the open front surface of the tub 20.

For example, in FIG. 2, an embodiment is shown in which the dish rack 50 includes the lower rack 51 located at a lower portion of the tub 20 to accommodate therein relatively large dishes, the upper rack 5 located on top of the lower rack 51 to accommodate therein medium-sized dishes, and the top rack 53 located at a top level of the tub 20 and capable of storing therein small dishes, etc. However, However, embodiments of present disclosure are not limited thereto. However, hereinafter, an example in which the dishwasher 1 includes the three dish racks 50 as shown is described.

Each of the lower rack 51, the upper rack 52, and the top rack 53 may be constructed to extend or retract from or into the inner space of the tub 20 through the open front surface of the tub 20.

For this purpose, guide rails 54 may be respectively disposed on both opposing inner side surfaces constituting an inner surface of the tub 20. As described below, by way of example, the guide rails may include an upper rail 542, a lower rail 541, and a top rail 543.

Wheels may be disposed on a bottom of each of the lower rack 51, the upper rack 52, and the top rack 53. The user may extend the lower rack 51, the upper rack 52, and the top rack 53 from the inner space of the tub 20 through the open front surface of the tub 20 and may place the dishes thereon, or easily withdraw the dishes that have been washed out thereof.

The guide rail (not shown) may be embodied as a simple rail-type fixed guide rail to guide the extending or the retracting of the rack 50, or a telescopic guide rail capable of guiding the extending or the retracting of the rack 50 and at the same time, increasing an extension distance thereof as the rack 50 further extends from the inner space of the tub.

In one example, the door 30 is configured for opening/closing the open front surface of the tub 20 as described above.

A hinge (not shown) around which the door 30 is closed or opened may be provided at a bottom of the open front surface. Thus, the door 30 may pivot around the hinge as a pivot axis in a top-down manner.

In this regard, a handle 31 for opening the door 30 and a control panel 32 for controlling an operation of the dishwasher 1 may be disposed on an outer side surface of the door 30.

As shown, the control panel 32 may include a display 33 that visually displays information regarding a current operating status of the dishwasher 1, etc.

Further, the control panel 32 may include a button unit 34 including a selection button through which a user's course selection manipulation is input and a power button through which a user's manipulation for turning the dishwasher on and off is input.

In one example, a rear panel 30b constituting an inner side surface of the door 30 may constitute one surface of the tub 20 when the door 30 has been closed, and may constitute a seat surface on which the lower rack 51 of the dish rack 50 is supported when the door 30 is fully opened.

For this purpose, when the door 30 is fully opened downwardly, the rear panel 30b of the door 30 may constitute a horizontal plane extending in the same direction as a direction in which the guide rail 54 guiding the displacement of the lower rack 51 extends.

As shown in FIG. 3, a detergent supply device 200 for automatically supplying detergent into the inside of the tub 20 may be further installed on the rear panel 30b constituting an inner side surface of the door 30.

Furthermore, a door position sensor 36 may be disposed on an outer top surface of the tub 20 and may be configured to detect whether the door 30 is in a closed or open state. For example, the door position sensor 36 may include a door position sensor S_d or a latch sensor that detects a position of a door latch (not shown).

In one example, a drying air supply 80 may be disposed under the tub 20 and may be configured to generate and supply high-temperature or low-temperature drying air to the washing space inside the tub 20.

As shown, the drying air supply 80 may be configured to include a filter member 883 for filtering outside air, a blower fan 825 for generating a drying air stream, a heater 84 for heating the drying air stream, and an air stream guide 83 disposed inside the tub 20 so as to guide the drying air stream.

A drying air supply hole 254 may be defined in a lower wall of the tub 20 so that high-temperature drying air generated by the drying air supply 80 may be introduced into the inside of the tub 20 through the drying air supply hole.

Thus, the high-temperature drying air or low-temperature drying air may be supplied from the drying air supply 80 into the inside of the tub 20 during the drying cycle S5 such that the drying efficiency and sterilization effect on the dishes may be significantly improved compared to a conventional dishwasher.

In one example, the dishwasher may be configured such that a portion of the air current supplied to the inside of the tub 20 and moistened while drying the dishes may be discharged to the outside and a remaining portion thereof may be suctioned into the drying air supply 80. The discharge of the air current may be accomplished via partial opening of the door 30 or via a separate air discharge means (not shown).

A suction duct 81 for recovering wet air from the tub 20 may be disposed on an outer side of a left wall 26 or an outer side of a right wall 27 of the tub 20.

In addition, a lighting device 71 may be further disposed inside the tub 20 as a means for illuminating the washing space 21 by irradiating light.

The lighting device 71 may be disposed on at least one of a rear wall 23, an upper wall 24, the right wall 27, and the left wall 26 forming inner surfaces 20in of the tub 20 so as to effectively illuminate the washing space 21.

Even in a situation in which the above-described dish rack 50 has not been extended out of the tub 20, the user may effectively check a stored state, a washed state, and the like of the dishes accommodated in the dish rack 50 through the lighting device 71.

To minimize power consumption, the lighting device 71 may be turned on by receiving power only when it is identified through the door position sensor 36 that the door 30 is opened.

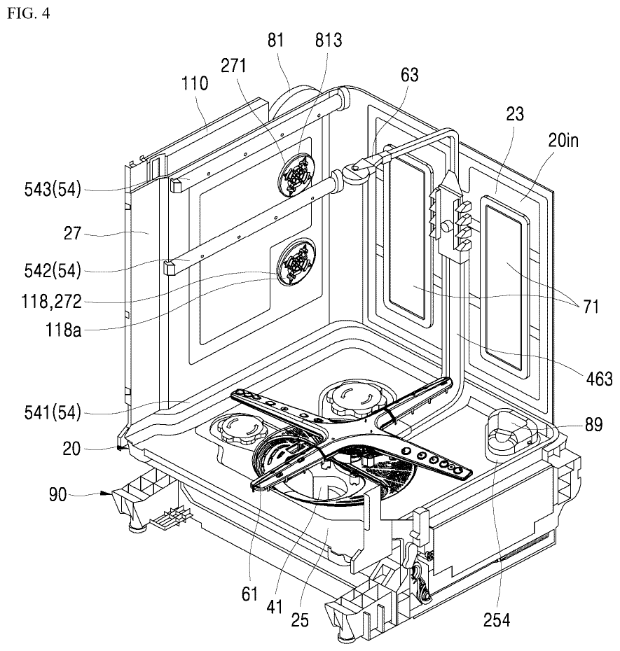

A detailed configuration of the lighting device 71 will be described later with reference to FIG. 4 and following drawings.

### Location and Arrangement of Lighting Devices

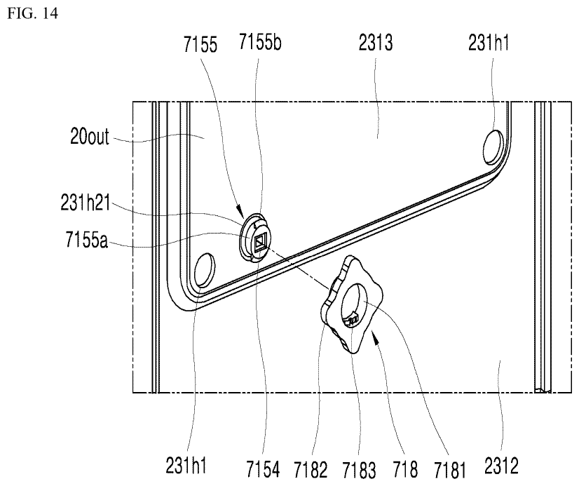

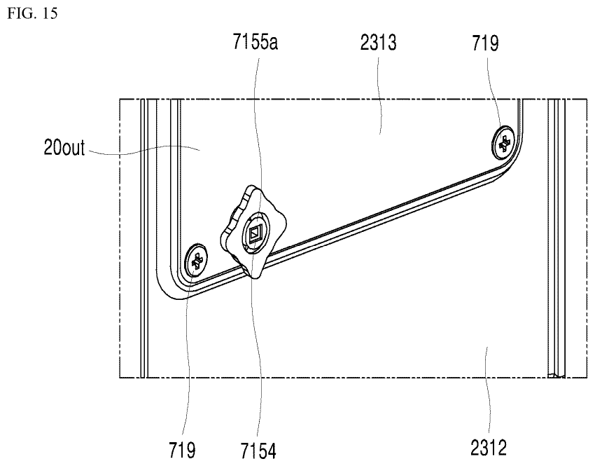

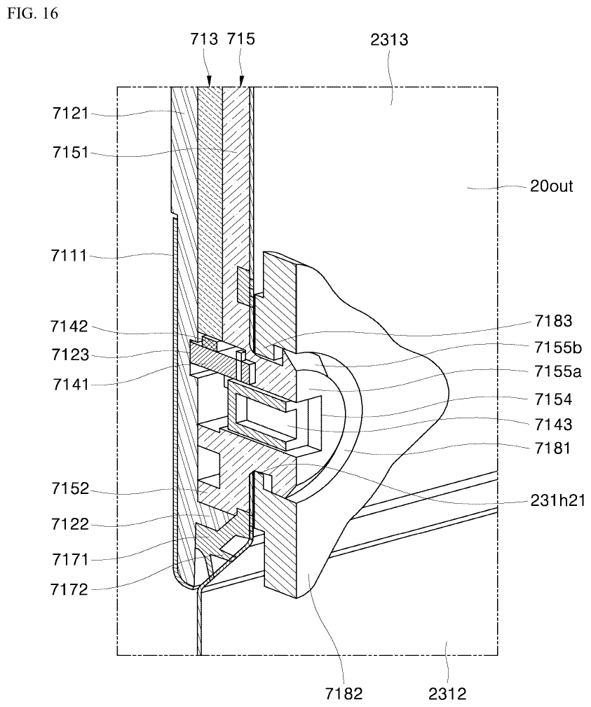

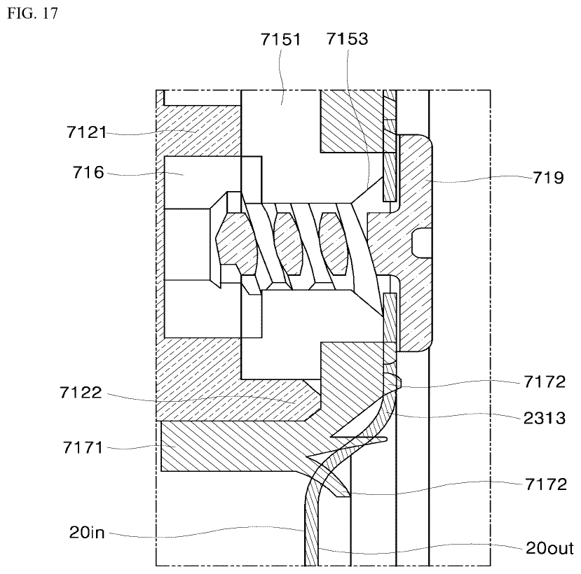

Hereinafter, the lighting device 71 according to an embodiment of the present disclosure will be described with reference to FIGS. 4 to 19.

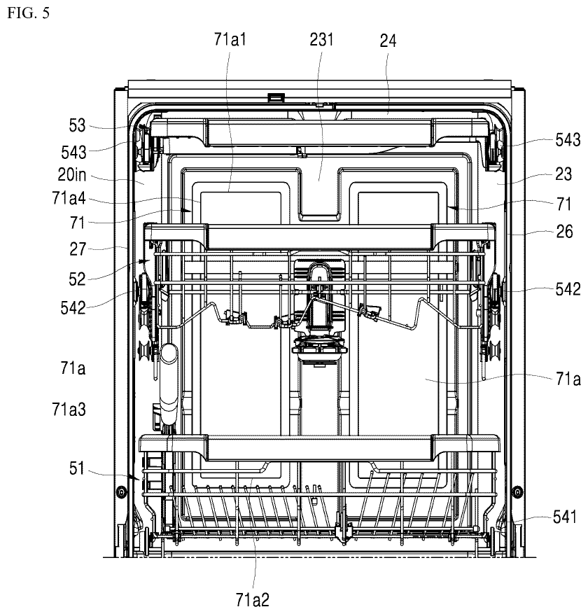

First, referring to FIGS. 4 and 5, the lighting device 71 according to an embodiment of the present disclosure may be disposed to be fixed to the inner surface 20in of the tub 20.

As shown in FIG. 4 and following drawings, illustratively, the lighting device 71 may be fixed and fastened to the inner surface 20in of the rear wall 23 of the tub 20.

More specifically, as shown in FIG. 4, a water jacket 110 in which washing water to be supplied to the tub 20 and used during washing and rinsing of the dishes is stored may be attached to an outer surface of the right wall 27 of the tub 20.

In this regard, a tub hole 118 allowing an inner space to be in communication with the washing space 21 of the tub 20 may be defined in the water jacket 110.

A water jacket communication hole 272 may be defined through the right wall 27 of the tub 20 to correspond to the tub hole 118.

A grill cap 118a having a shape similar to that of a grill cap 813 of an air suction hole 271 may be coupled to the tub hole 118 to minimize an inflow of washing water and prevent an inflow of foreign substances.

In addition, as described above, a drying air supply 80 that heats air discharged from the tub 20 during a drying process and re-supplies heated air to the tub 20 again may be disposed under the tub 20.

As shown, the drying air supply 80 may include the suction duct 81 that sucks air discharged from the tub 20.

The suction duct 81 may be disposed on the outer side of the left wall 26 or the right wall 27 of the tub 20.

For example, FIG. 4 illustrates a configuration in which the suction duct 81 is disposed in parallel with the water jacket 110 on the outer surface of the right wall 27 of the tub 20.

Accordingly, the air suction hole 271 may be defined through the right wall 27 of the tub 20, and the grill cap 8113 coupled to an inlet of the suction duct 81 may be fixed into the air suction hole 271.

However, this is merely exemplary, and the suction duct 81 may be disposed on the outer surface of the left wall 26 of the tub 20.

As described above, in consideration of positional restrictions where the suction duct 81 of the drying air supply 80 and the water jacket 110 are disposed, the lighting device 71 may be fixed to the inner surface 20in of the rear wall 23 of the tub 20 as a position capable of minimizing interference with the suction duct 81 of the drying air supply 80 and the water jacket 110.

In one example, a plurality of lighting devices 71 according to an embodiment of the present disclosure may be equipped. More specifically, as shown, a pair of lighting devices 71 having the same size and outer appearance may be equipped as an example.

In this regard, as the pair of lighting devices 71 have the same size and outer appearance, they may be disposed and arranged on the rear wall 23 of the tub 20 to be interchangeable with each other.

As described above, as the pair of lighting devices 71 are equipped, the number of lighting devices 71 may be minimized.

In addition, as will be described later, the number of screw holes 231ₕ1 and through holes 231ₕ21 and 231ₕ22 to be defined in the rear wall 23 of the tub 20 for fastening the lighting device 71 may be minimized.

In this regard, the pair of lighting devices 71 may be arranged at positions symmetrical to other in a left-right direction around a water guide defining the second supply flow path 463 described above.

As shown in FIG. 5, a formed area 231 concavely recessed rearwards for installation of the second supply flow path 463 may be defined in the rear wall 23 of the tub 20.

More specifically, as will be described below, the formed area 231 may include a first formed area 2311 defined by performing primary bead forming rearwards on the rear wall 23.

The water guide defining the second supply flow path 463 may be disposed in and fastened to the first formed area 2311 so as to extend along an up-down direction while being positioned between the pair of lighting devices 71.

To increase lighting efficiency for the washing space 21 of the tub 20 and minimize interference with the second supply flow path 463, the pair of lighting devices 71 may be arranged to be spaced apart from each other along the left-right direction with the water guide defining the second supply flow path 463 interposed therebetween.

As will be described later, the pair of lighting devices 71 may be disposed at a second formed area 2312 and a lighting device-mounted formed area 2313 formed by additionally bead forming an inner area of the first formed area 2311.

As described above, the pair of lighting devices 71 may be formed to have the same shape and size, only with the different positions.

Therefore, hereinafter, a description will be made focusing on the lighting device 71 disposed on a left side. However, unless otherwise described, contents described below may be equally applied to the lighting device 71 disposed on a right side.

As shown in FIG. 5, the lighting device 71 according to an embodiment of the present disclosure is configured to illuminate the inside of the tub 20 in a surface light-emitting method.

In this regard, a light-emitting surface 71a of the lighting device 71 may be disposed in parallel with the rear wall 23 of the tub 20 so as to effectively illuminate the inside of the tub 20.

The light-emitting surface 71a of the lighting device 71 may be formed in a rectangular shape.

More specifically, the light-emitting surface 71a of the lighting device 71 may be formed in the rectangular shape in which a width in an up-down direction (U-D direction) is greater than a width in the left-right direction (Le-Ri direction).

However, in the illustrated embodiment, the light-emitting surface 71a of the lighting device 71 is formed as a simple plane having the rectangular shape, but the present disclosure is not limited thereto. The light-emitting surface 71a of the lighting device 71 may be formed as a curved surface having a predetermined curvature or may have a polygonal shape rather than the rectangular shape, and it will be considered that such a modification naturally falls within the scope of the present disclosure.

In this regard, as shown in FIG. 5, an upper edge 71a1 of the light-emitting surface 71a having the rectangular shape may be positioned to be disposed between the top rail 543 and the upper rail 542 based on the up-down direction.

Preferably, the upper edge 71a1 of the light-emitting surface 71a may be located closer to the top rail 543 than to the upper rail 542.

That is, the upper edge 71a1 of the light-emitting surface 71a of the lighting device 71 may be disposed at a position higher than an upper end of the upper rack 52.

Accordingly, the upper edge 71a1 of the light-emitting surface 71a may be positioned between lower end of the top rack 53 supported so as to be extendable by the top rail 543 and the upper end of the upper rack 52 supported so as to be extendable by the upper rail 542.

In addition, a lower edge 71a2 of the light-emitting surface 71a having the rectangular shape may be positioned to be disposed between the upper rail 542 and the lower rail 541 based on the up-down direction (U-D direction).

More specifically, it may be located closer to the lower rail 541 than to the upper rail 542.

Accordingly, the lower edge 71a2 of the light-emitting surface 71a may be disposed at a position lower than an upper end of the lower rack 51 that is supported so as to be extendable by the lower rail 541.

Accordingly, light may be evenly irradiated to the dishes respectively accommodated in the top rack 53, the upper rack 52, and the lower rack 51.

As the positions of the upper edge 71a1 and the lower edge 71a2 of the light-emitting surface 71a of the lighting device 71 are set as described above, the width in the up-down direction (U-D direction) of the light-emitting surface 71a may be expanded at least compared to the related art, and thus a light emitting area size of the light-emitting surface 71a may be significantly expanded.

More specifically, the light emitting area size of the light-emitting surface 71a formed on each of the pair of lighting devices 71 may be secured to be equal to or greater than 20% of an area size of the rear wall 23 of the tub 20.

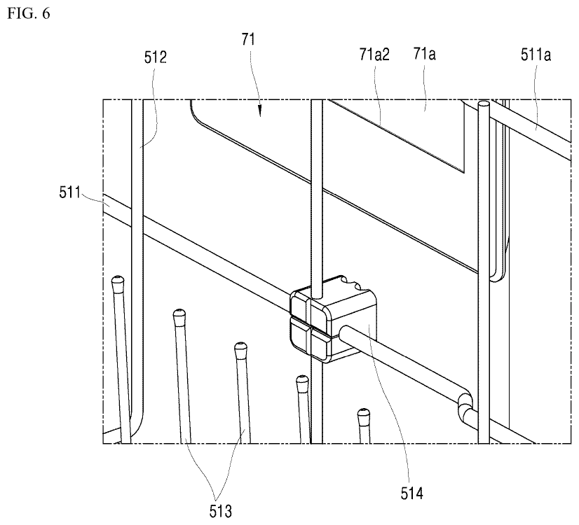

However, as illustrated in FIG. 6, the lower edge 71a2 of the light-emitting surface 71a is disposed at a position lower than an uppermost horizontal wire 511a disposed at the highest position among horizontal wires 511 constituting the lower rack 51. Accordingly, the light-emitting surface 71a of the lighting device 71 has a possibility of colliding with a rear end of the lower rack 51 disposed so as to be movable along the front-rear direction (F-R direction).

More specifically, there is a high possibility that the lighting device 71 is damaged as the uppermost horizontal wire 511a and a vertical wire 512 constituting the rear end of the lower rack 51 collide with the lighting device 71.

In particular, as will be described below, a diffusion plate 712 and a light guide plate 713 made of a transparent material to form the light-emitting surface 71a may be broken or damaged by an impact from a direct collision.

As a means for preventing such a collision between the lower rack 51 and the lighting device 71, as shown in FIG. 6, a bumper 514 disposed to protrude rearwards from the rear end of the lower rack 51 may be disposed at the rear of the lower rack 51.

As in the embodiment, when the pair of lighting devices 71 are equipped, a pair of bumpers 514 may be equipped to correspond thereto so as to be allocated to the left lighting device 71 and the right lighting device 71, respectively.

The bumper 514 serves to absorb the impact caused by the collision between the lower rack 51 and the lighting device 71.

To this end, the bumper 514 may be made of an elastic material having a predetermined elasticity. Illustratively, the bumper 514 may be formed by injection molding of a material that is easy to process, such as natural rubber or synthetic rubber.

In addition, to maximize the impact absorption effect, as shown in FIG. 6, multiple embossed protrusions protruding rearwards may be disposed on a rear end surface of the bumper 514.

As the multiple embossed protrusions are disposed on the rear end surface, the multiple protrusions are effectively elastically deformed when the collision or contact with the rear wall 23 of the tub 20 occurs to absorb the impact caused by the collision, so that noise resulted from the collision may be effectively prevented.

To prevent the collision and contact with the lighting device 71, a protruding height at which the bumper 514 protrudes from the rear end of the lower rack 51 may be greater than a height at which the lighting device 71 protrudes from the inner surface 20in of the rear wall 23 of the tub 20.

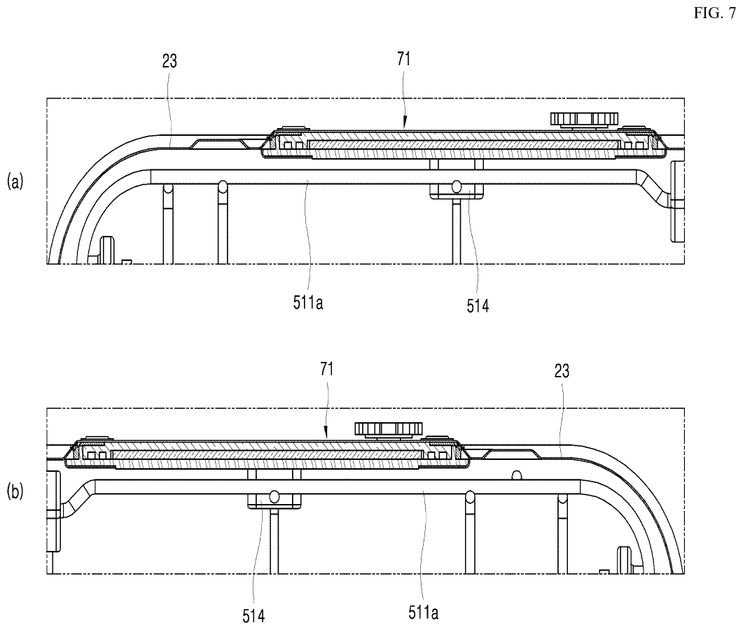

Accordingly, as shown in FIG. 7, even when the lower rack 51 moves to a position as close as possible to the rear wall 23 of the tub 20 up to a rearmost position, the rear end of the lower rack 51 may be prevented from being in direct contact with or colliding with the lighting device 71.

In addition, it is necessary to prevent the bumper 514 from being in direct contact with the lighting device 71.

To this end, as shown in FIG. 6, the bumper 514 may be coupled to the horizontal wire 511 disposed at a lower position than the uppermost horizontal wire 511a forming a rear upper end of the lower rack 51 and disposed at a lower position in the up-down direction (U-D direction) than the lighting device 71.

In this regard, to increase a coupling strength with respect to the lower rack 51, as shown, the bumper 514 may be coupled at a position where the horizontal wire 511 and the vertical wire 512 intersect each other.

In addition, to effectively protect the light-emitting surface 71a of the lighting device 71, as shown in FIG. 7, the bumper 514 may be disposed to be connected to a vertical wire 512 disposed closest to an intermediate position between a left edge 71a3 and a right edge 71a4 of the light-emitting surface 71a in the left-right direction (Le-Ri direction).

In one example, the bumper 514 may be separately manufactured through the injection molding as described above, and coupled to a portion where the horizontal wire 511 and the vertical wire 512 intersect each other in the lower rack 51. Alternatively, the bumper 514 may be coupled to the lower rack 51 through insert injection at the portion where the horizontal wire 511 and the vertical wire 512 intersect each other.

In one example, as will be described later, the lighting device 71 according to an embodiment of the present disclosure may be entirely disposed inside the tub 20 except for a first connection protrusion 7155 and a second connection protrusion 7156 and fastened to the inner surface 20in of the tub 20.

Accordingly, an opening defined to have an area size corresponding to that of the light-emitting surface 71a as a light source is disposed at the rear of and out of the tub 20 as in the related art may be omitted from the tub 20.

As will be described later, only the through holes 231h21 and 231h22 through which the connection protrusions 7155 and 7156 for preliminarily fastening the lighting device 71 pass and a screw hole 231h1 for finally fastening the lighting device 71 may be defined in the rear wall 23 of the tub 20 of the dishwasher 1 according to the present disclosure.

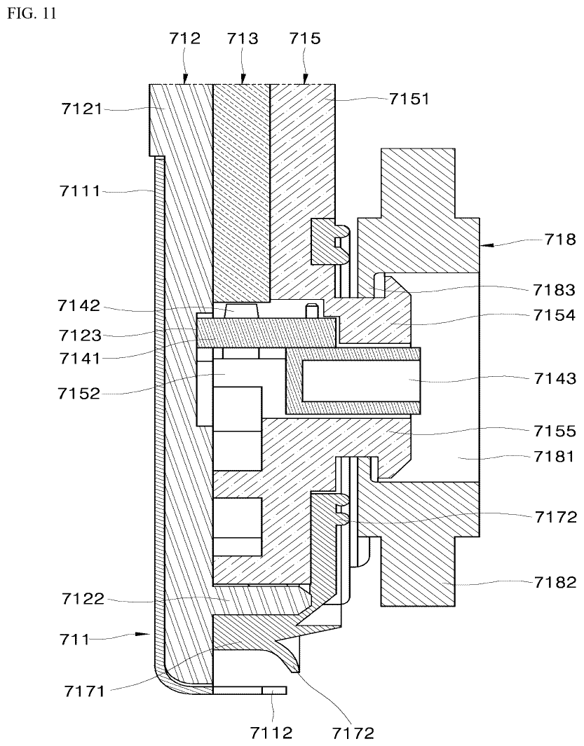

Detailed configurations of a preliminary fastening structure and a final fastening structure for the lighting device 71 will be described later with reference to FIG. 11 and following drawings.

### Detailed Configuration of Lighting Device

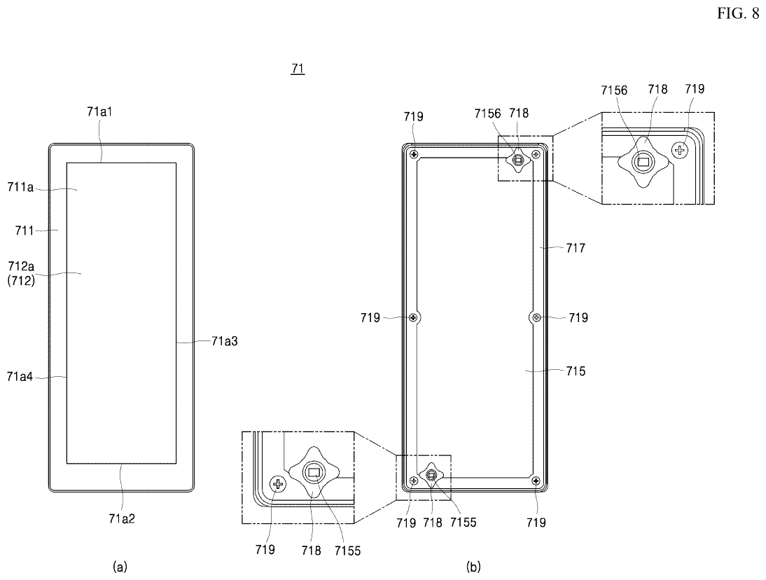

Hereinafter, the detailed configuration of the lighting device 71 according to an embodiment of the present disclosure will be described with reference to FIGS. 8 to 10.

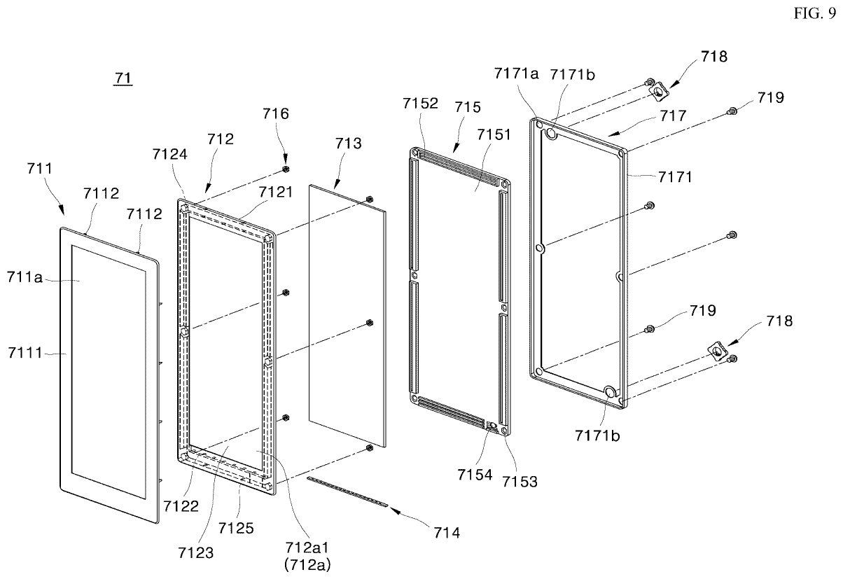

As shown in FIGS. 8 and 9, the lighting device 71 according to an embodiment of the present disclosure may include a light source 714 that generates light.

In addition, the lighting device 71 may include the light guide plate 713 that switches a travel path of light generated by the light source 714.

In addition, the lighting device 71 may include the diffusion plate 712 disposed in front of the light guide plate 713 and forming the light-emitting surface 71a.

In addition, the lighting device 71 may include a rear cover 715 disposed at the rear of the light guide plate 713 and coupled to the diffusion plate 712.

In addition, the lighting device 71 may include a front cover 711 coupled to a front side of the diffusion plate 712.

In addition, the lighting device 71 may include a gasket 717 coupled to a rear surface of the rear cover 715.

First, the light source 714 serves to generate light by receiving power from the outside.

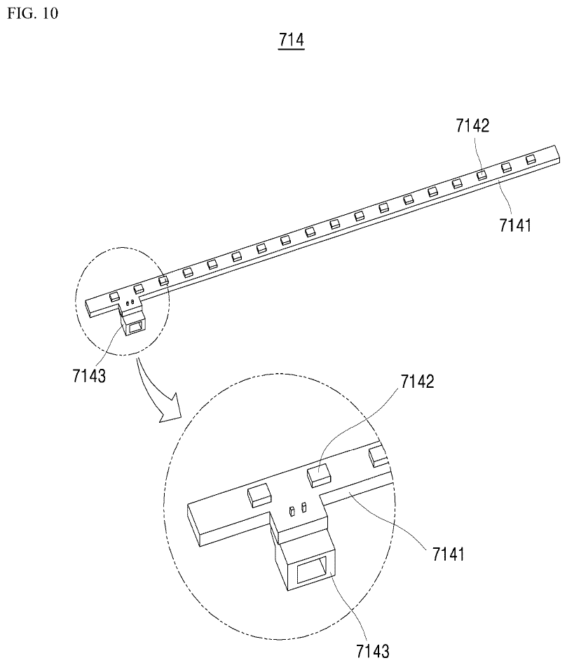

More specifically, as shown in FIGS. 9 and 10, the light source 714 may include at least one light source element 7142 and a circuit board 7141 on which the at least one light source element 7142 is mounted as an example.

The light source element 7142 may be applied without limitation as long as it is a means capable of receiving power and generating a predetermined amount of light. The light source element 7142 may be, for example, an LED element.

The present disclosure is not limited thereto, but hereinafter, a description will be made based on an embodiment in which the LED element is applied as the light source element 7142.

As shown, to minimize a size of the lighting device 71 in the front-rear direction and minimize the number of light source elements 7142, light generated from the light source element 7142 may be introduced into the light guide plate 713 through one side end of the light guide plate 713.

As shown in FIGS. 9 and 10, the light source element 7142 may be disposed to irradiate light toward a lower edge of the light guide plate 713 as an example. To this end, the circuit board 7141 and the light source element 7142 may be arranged parallel to the lower edge of the light guide plate 713.

However, the present disclosure may not be limited thereto, and the circuit board 7141 and the light source element 7142 may be arranged parallel to an upper edge or left and right edges of the light guide plate 713. In addition, to increase an amount of light emitted, a circuit board 7141 and a light source element 7142 arranged parallel to the upper edge or the left and right edges of the light guide plate 713 may be further equipped.

Hereinafter, for convenience, a description will be made based on the configuration in which the circuit board 7141 and the light source element 7142 are arranged parallel to the lower edge of the light guide plate 713.

As described above, when the circuit board 7141 and the light source elements 7142 are arranged parallel to the lower edge of the light guide plate 713, a width in the front-rear direction (F-R direction) of the circuit board 7141 may be smaller than a width in the left-right direction thereof. That is, the left-right direction (Le-Ri direction) may be a longitudinal direction of the circuit board 7141.

In this regard, as shown in FIG. 10, to minimize a width in the front-rear direction (F-R direction) of the lighting device 71, the width in the front-rear direction of the circuit board 7141 may be slightly greater than or equal to a thickness in the front-rear direction (F-R direction) of the light guide plate 713.

In consideration of the width in the front-rear direction (F-R direction) of the circuit board 7141, as shown in FIG. 11, a substrate groove 7123 defined to be concave frontwards may be defined in a rear surface of the diffusion plate 712 such that the circuit board 7141 may be at least partially accommodated therein.

In one example, a connector 7143 for receiving power from the outside may be coupled to the circuit board 7141. The connector 7143 may be electrically connected to a harness (not shown).

In an embodiment, the connector 7143 may be connected to a position adjacent to a right end of the circuit board 7141.

To secure a minimum contact area size with respect to the connector 7143, a connection portion 7141a protruding rearwards may be formed on the circuit board 7141.

The connector 7143 and the harness may be inserted into a passage 7154 defined inside a first connection protrusion 7155 to be described later.

As will be described later, the passage 7154 defined inside the first connection protrusion 7155 may extend from a rear end of the first connection protrusion 7155 into the lighting device 71 passing through the rear cover 715.

In one example, the plurality of light source elements 7142 may be linearly arranged along the longitudinal direction of the circuit board 7141, that is, along the left-right direction, such that light may be evenly projected through the lower edge of the light guide plate 713.

In the shown embodiment, spacings between the respect two light source elements 7142 in the left-right direction (Le-Ri direction) is approximately equal to each other.

However, the present disclosure is not limited thereto. In consideration of a light overlapping effect at a center of the circuit board 7141, the spacings between the respect two light source elements 7142 in the left-right direction (Le-Ri direction) may gradually decrease in a direction toward the left edge or the right edge.

In one example, the light guide plate 713 serves to switch the travel path of light generated from the light source element 7142 toward the diffusion plate 712 disposed in the front.

To this end, the light guide plate 713 may be formed by processing a transparent material into a plate shape. The light guide plate 713 may be disposed such that the front-rear direction (F-R direction) becomes a thickness direction thereof in consideration of the size in the front-rear direction (F-R direction) of the lighting device 71.

As described above, light generated by the light source element 7142 may be introduced into the light guide plate 713 through the lower edge of the light guide plate 713.

Light introduced into the light guide plate 713 may be reflected and dispersed, and thus, a travel direction thereof may be switched toward a front surface of the light guide plate 713 disposed parallel to the rear surface of the diffusion plate 712 to be described later.

Remaining rear surface, upper edge, left edge, and right edge of the light guide plate 713 except for the front surface thereof may be covered by the rear cover 715 to be described later, and thus transmission of light thereto may be blocked.

Accordingly, light may not be able to pass through the rear surface, the upper edge, the left edge, and the right end of the light guide plate 713, and light may be irradiated to the outside of the light guide plate 713 only through the front surface of the light guide plate 713.

In one example, the diffusion plate 712 forms the light-emitting surface 71a, and serves to uniformly diffuse light introduced through the light guide plate 713 toward the light-emitting surface 71a.

The light guide plate 713 may include a plate-shaped plate body 7121 forming the light-emitting surface 71a of the lighting device 71.

A front surface 712a of the plate body 7121 may be divided into an exposed surface 712a1 that is exposed toward the washing space 21 of the tub 20 and a non-exposed surface.

The exposed surface 712a1 may be an inner area of the front surface 712a of the plate body 7121, and the non-exposed surface may be an outer area of the front surface 712a of the plate body 7121.

The non-exposed surface corresponds to an area coupled with the front cover 711 to be described later and covered by the front cover 711.

An accommodating space-defining rib 7122, a nut groove 7124, and the substrate groove 7123 of the diffusion plate 712 may be disposed at the rear of the non-exposed surface as shown in FIGS. 9 and 11 so as to be covered by the front cover 711.

In addition, the light source 714, a fastening nut 716 to be described later, a reinforcing rib 7152 of the rear cover 715 to be described later, and a screw hole 7153 defined in the rear cover 715 may be disposed at the rear of the non-exposed surface so as to be covered by the front cover 711.

In addition, the gasket 717 for blocking the introduction of washing water and the foreign substances into the lighting device 71 may be disposed at the rear of the non-exposed surface so as to be covered by the front cover 711.

The non-exposed surface of the front surface 712a of the plate body 7121 may be formed as a stepped surface formed to be concave rearwards with respect to the exposed surface 712a1.

A step formed between the exposed surface 712a1 and the non-exposed surface may have a thickness equal to or slightly greater than a thickness of the front cover 711.

Accordingly, an area of the diffusion plate 712 to which the front cover 711 is coupled may be effectively guided.

In addition, a step between the exposed surface of the diffusion plate 712 and a front surface of the front cover 711 may be minimized.

In one example, the diffusion plate 712 may also serve to protect and accommodate therein light guide plate 713, the light source 714, and the rear cover 715 disposed at the rear.

To this end, the diffusion plate 712 may include the accommodating space-defining rib 7122 protruding rearwards from the rear surface of the plate body 7121.

The accommodating space-defining rib 7122 may be formed in a barrier shape protruding from the rear surface such that a predetermined accommodating space with an open rear surface may be defined at the rear of the plate body 7121.

The above-described light guide plate 713 and light source 714 may be entirely accommodated in the accommodating space defined inwardly of the accommodating space-defining rib 7122. In addition, the rear cover 715 to be described later may be coupled in a state of being at least partially inserted into and accommodated in the accommodating space of the accommodating space-defining rib 7122.

In this regard, as will be described later, in consideration of a shape of the lighting device-mounted formed area 2313 of the tub 20 to which the lighting device 71 is coupled, the accommodating space-defining rib 7122 may be disposed at a position spaced inwardly apart from an outer edge of the plate body 7121 by a predetermined spacing.

In addition, a protruding height of the accommodating space-defining rib 7122 from the rear surface of the plate body 7121 may be uniformly maintained.

In addition, for effective accommodation of the components into the accommodating space defined inwardly of the accommodating space-defining rib 7122 and for increasing a coupling force with respect to the rear cover 715 to be described later, the protruding height of the accommodating space-defining rib 7122 may be equal to or greater than a protruding height of the reinforcing rib 7152 of the rear cover 715.

In one example, the nut groove 7124 into which the fastening nut 716 is inserted may be defined in an area defined outwardly of the accommodating space-defining rib 7122.

More specifically, the nut groove 7124 defined to be concave frontwards may be defined in an outer area defined between the accommodating space-defining rib 7122 and an outer edge of the diffusion plate 712.

In the embodiment shown in FIG. 9, a configuration in which a total of six fastening nuts 716 are equipped, and a total of six nut grooves 7124 are equipped corresponding thereto is shown.

However, this is merely an example. The number of fastening nuts 716 and the number of nut grooves 7124 equipped may be adjusted based on the width in the up-down direction (U-D direction) and the width in the left-right direction (Le-Ri direction) of the lighting device 71.

As in the embodiment, when the total of six fastening nuts 716 and the total of six nut grooves 7124 are equipped, as illustrated, three fastening nuts 716 and three nut grooves 7124 may be arranged at positions spaced apart from each other in the up-down direction (U-D direction) along the left edge of the diffusion plate 712.

In addition, the remaining three fastening nuts 716 and the three nut grooves 7124 may be arranged at positions spaced apart from each other in the up-down direction (U-D direction) along the right edge of the diffusion plate 712.

In the illustrated embodiment, pairs of the fastening nuts 716 and the nut grooves 7124 the total of six fastening nuts 716 and the total of six nut grooves 7124 are arranged at positions of the diffusion plate 712 symmetrical to each other in both the up-down direction (U-D direction) and the left-right direction (Le-Ri direction).

However, as will be described later, to prevent the lighting device 71 from being misassembled in the process of finally fastening the lighting device to the rear wall 23 of the tub 20, at least some pairs of the fastening nuts 716 and the nut grooves 7124 may be arranged at positions asymmetrical to each other.

Illustratively, two pairs of the fastening nuts 716 and the nut grooves 7124 arranged at intermediate positions in the up-down direction (U-D direction) may be arranged at positions asymmetrical to each other in the left-right direction (Le-Ri direction).

In one example, the fastening nut 716 inserted into and coupled to the nut groove 7124 may be screwed to a screw bolt 719 for the final fastening of the lighting device 71.

As will be described below, the screw bolt 719 may be coupled to the rear wall 23 of the tub 20 extending therethrough from the outside of the tub 20.

The screw bolt 719 may be screwed to the fastening nut 716 by extending through the screw hole 231h1 defined through the rear wall 23 of the tub 20 and the screw hole 7153 defined in the rear cover 715, so that the lighting device 71 may be finally-fastened to the rear wall 23 of the tub 20.

Accordingly, the plurality of fastening nuts 716 and the plurality of screw bolts 719 constitute a second fastening portion for the final fastening of the lighting device 71.

In one example, a plurality of edge grooves 7125 may be defined in an outer peripheral surface of the diffusion plate 712.

A fastening tab 7112 of the front cover 711 to be described later may be coupled to each edge groove 7125 while being plastically deformed.

Corresponding to an extending direction of the fastening tab 7112, each edge groove 7125 may extend along the front-rear direction (F-R direction), and a width of the edge groove 7125 may be uniformly maintained along the front-rear direction (F-R direction).

In one example, the rear cover 715 is coupled to a rear portion of the accommodating space of the diffusion plate 712 in which the light guide plate 713 and the light source 714 are accommodated, and closes the rear surface of the accommodating space, thereby protecting the light guide plate 713 and the light source 714.

To this end, the rear cover 715 may include a plate-shaped plate body 7151 that is at least partially inserted into and coupled to the space defined by the accommodating space-defining rib 7122 of the diffusion plate 712.

As described above, to increase the lighting efficiency by allowing light generated from the light source 714 to be transmitted to the diffusion plate 712 only through the front surface of the light guide plate 713, the plate body 7121 of the rear cover 715 may be made of an opaque material through which light is not able to pass through injection molding.

In addition, to increase light emitting efficiency, a material having a low light absorption rate may be applied to the plate body 7121.

In one example, the diffusion plate 712 may include the reinforcing rib 7152 protruding frontwards from a front surface of the plate body 7121.

In a similar manner to the above-described accommodating space-defining rib 7122, the reinforcing rib 7152 may be formed in a barrier shape extending along an outer edge of the plate body 7121.

As the reinforcing rib 7152 is integrally formed with the plate body 7121 along the outer edge of the plate body 7121, a rigidity of the plate body 7121 formed in the simple plate shape may be reinforced.

In addition, when coupled to the accommodating space-defining rib 7122 of the diffusion plate 712, the reinforcing rib 7152 of the rear cover 715 is disposed to be entirely inserted into the accommodating space of the diffusion plate 712.

In addition, the reinforcing rib 7152 of the rear cover 715 may be coupled to the accommodating space-defining rib 7122 in a state of being in surface contact therewith.

Accordingly, a coupling area size between the diffusion plate 712 and the rear cover 715 may be expanded, and washing water or the foreign substances may be prevented from being introduced into the accommodating space.

However, as shown in FIG. 9, unlike the accommodating space-defining rib 7122 of the diffusion plate 712, the reinforcing rib 7152 of the rear cover 715 may be discontinuously formed.

That is, the reinforcing rib 7152 of the rear cover 715 may be formed as multiple divided bodies.

As shown, the screw hole 7153 through which the screw bolt 719 for the final fastening of the lighting device 71 extends may be defined between each pair of the reinforcing ribs 7152.

In one example, the passage 7154 defined to extend through the plate body 7121 along front-rear direction (F-R direction) may be defined at the lower edge.

The passage 7154 provides a space into which the connector 7143 and the connection portion 7141a of the light source 714 described above are inserted.

In addition, as shown in FIG. 11, the passage 7154 may extend from the accommodating space of the diffusion plate 712 to the inside of the first connection protrusion 7155 to be described later.

Accordingly, an inner space of the lighting device 71 and a space outside the tub 20 may be in communication with each other through the passage 7154.

In one example, as illustrated in FIG. 11, the rear cover 715 may include the pair of connection protrusions 7155 and 7156 protruding rearwards from the rear surface of the plate body 7121.

More specifically, the pair of connection protrusions 7155 and 7156 may include the first connection protrusion 7155 and the second connection protrusion 7156 arranged at positions spaced apart from each other on the rear surface of the plate body 7121 of the rear cover 715.

In this regard, the rear surface of the rear cover 715 forming a rear surface of the lighting device 71 may refer to a surface coupled to the inner surface 20in of the tub 20, and the rearward direction may be a direction in which the rear surface faces. That is, when the lighting device 71 is coupled to the left wall 26 or the right wall 27 of the tub 20, the rear surface of the lighting device 71 being directed rearwards may mean that a surface thereof coupled to the left wall 26 or the right wall 27 of the tub 20 is directed in a lateral direction.

In this regard, the first connection protrusion 7155 and the second connection protrusion 7156 may be arranged on the rear surface of the plate body 7121 at positions spaced apart from each other along the up-down direction (U-D direction).

Alternatively, the first connection protrusion 7155 and the second connection protrusion 7156 may be arranged on the rear surface of the plate body 7121 at positions spaced apart from each other along a diagonal direction.

FIG. 9 and following drawings show an embodiment in which the first connection protrusion 7155 and the second connection protrusion 7156 are arranged at the positions spaced apart from each other along the diagonal direction.

That is, illustratively, the first connection protrusion 7155 may be disposed at a corner between a lower edge and a left edge of the plate body 7121 of the rear cover 715.

In addition, illustratively, the second connection protrusion 7156 may be disposed at a corner between an upper edge and a right edge of the plate body 7121 of the rear cover 715.

However, the arrangement and arrangement positions of the first connection protrusion 7155 and the second connection protrusion 7156 may be modified differently based on the arrangement and arrangement position of the light source 714. Hereinafter, for convenience, a description will be made based on the configuration in which the first connection protrusion 7155 is disposed at the corner between the lower edge and the left edge of the plate body 7121 of the rear cover 715 and the second connection protrusion 7156 is disposed at the corner between the upper edge and the right edge of the plate body 7121 of the rear cover 715.

As will be described below, the lighting device 71 according to the present disclosure may be preliminarily-fastened to the rear wall 23 of the tub 20 before the final fastening using the second fastening portion including the screw bolt 719 and the fastening nut 716 is performed.

The first connection protrusion 7155 and the second connection protrusion 7156 constitute the first fastening portion for preliminarily fastening the lighting device 71 so as to guide a final fastening position before the final fastening is performed.

More specifically, as shown in FIG. 11, the first connection protrusion 7155 may include a body 7155a having one end becoming a fixed end integrally connected to the rear surface of the plate body 7121 of the rear cover 715 and the other end becoming a free end.

For example, the body 7155a of the first connection protrusion 7155 may be formed in a cylindrical shape.

A rear end of the body 7155a of the first connection protrusion 7155 formed in the cylindrical shape may extend through a first through hole 231h21 defined in the rear wall 23 of the tub 20 and protrude to the outside of the tub 20 during the preliminary fastening for guiding the final fastening position.

In addition, the first connection protrusion 7155 may include a hook protrusion 7155b integrally formed on an outer circumferential surface of the rear end of the first connection protrusion 7155.

In this regard, a pair of hook protrusions 7155b may be equipped, and the pair of hook protrusions 7155b may be arranged at positions spaced apart from each other along a circumferential direction of the body 7155a.

Illustratively, the pair of hook protrusions 7155b may be arranged at positions symmetrical to each other around a center of the first connection protrusion 7155.

In addition, each hook protrusion 7155b may be formed to have a shape in which a vertical cross-sectional area is reduced frontwards from the rear end.

To this end, for example, an outer circumferential surface of the hook protrusion 7155b may be formed as an inclined surface having an upward inclination angle in a direction it extends frontwards.

In this regard, a maximum outer diameter formed between the pair of hook protrusions 7155b may be greater than or equal to a diameter of the first through hole 231h21 defined in the rear wall 23 of the tub 20.

In addition, an outer diameter of the body 7155a of the first connection protrusion 7155 may be smaller than the diameter of the first through hole 231h21.

With such shape and arrangement of the pair of hook protrusions 7155b as described above, during the preliminary fastening of the lighting device 71, an engaged state in which the first connection protrusion 7155 is able to easily enter the first through hole 231h21 rearwards, but is not able to easily deviate frontwards may be formed.

As shown in FIG. 11, a holder 718 may be coupled to the pair of hook protrusions 7155b of the first connection protrusion 7155 for the preliminary fastening of the lighting device 71.

More specifically, a cylindrical hollow 7181 may be defined through the holder 718.

An inner diameter of the hollow 7181 may be set to be greater than or equal to the maximum outer diameter formed between the pair of hook protrusions 7155b.

Accordingly, the pair of hook protrusions 7155b may be entirely inserted into the hollow 7181.

A locking protrusion 7183 that is engaged with the pair of hook protrusions 7155b may be integrally formed on an inner circumferential surfaces of the hollow 7181.

Illustratively, the locking protrusion 7183 may be disposed on the inner circumferential surface of the hollow 7181 so as to extend spirally.

Accordingly, when the holder 718 is rotated after the pair of hook protrusions 7155b of the first connection protrusion 7155 are inserted into the holder 718, the locking protrusion 7183 of the holder 718 and one of the pair of hook protrusions 7155b are engaged with each other.

To facilitate such rotation coupling, the holder 718 may include a grip portion 7182 integrally formed on an outer circumferential side of the hollow 7181 and having a non-circular shape.

Accordingly, the holder 718 may be coupled to the first connection protrusion 7155, and the preliminarily-fastened state of the lighting device 71 with respect to the rear wall of the tub 20 may be formed.

Accordingly, the first connection protrusion 7155 of the rear cover 715 and the holder 718 constitute the first fastening portion for the preliminary fastening of the lighting device 71.

In one example, the second connection protrusion 7156 may have the same outer appearance and the same size as the first connection protrusion 7155, differing therefrom only in position.

Accordingly, the holders 718 having the same outer appearance and the same size may be coupled to the first connection protrusion 7155 and the second connection protrusion 7156 in an interchangeable manner for the preliminary fastening of the lighting device 71.

Therefore, a description redundant with that of the first connection protrusion 7155 will be omitted.

In one example, at least one of the first connection protrusion 7155 and the second connection protrusion 7156 may include the passage 7154 allowing the inner space of the lighting device 71 to be in communication with the space outside the tub 20.

As described above, at least one of the connector 7143 of the light source 714 and the harness electrically connected to the connector 7143 may be inserted into and coupled to the passage 7154.

In the present embodiment, the circuit board 7141 constituting the light source 714 is disposed along the lower edge of the light guide plate 713.

Accordingly, the passage 7154 through which the connector 7143 electrically connected to the circuit board 7141 and the harness are inserted and pass may be defined inside the first connection protrusion 7155.

Accordingly, the first connection protrusion 7155 may have a hollow shape in which the passage 7154 is defined, and the second connection protrusion 7156 may have a solid shape in which the passage 7154 is not defined.

However, this is merely an example. In an embodiment in which the light source 714 is disposed along the upper edge of the light guide plate 713, the passage 7154 may be defined inside the second connection protrusion 7156.

In addition, when a plurality of light sources 714 are arranged at each of the upper and lower edges of the light guide plate 713, the passages 7154 may be defined inside the first connection protrusion 7155 and inside the second connection protrusion 7156.

In addition, as in an embodiment of using multiple light sources, when the plurality of light sources 714 are equipped, depending on design conditions, connection protrusions may be additionally equipped, and passages may be defined in the plurality of connection protrusions, respectively.

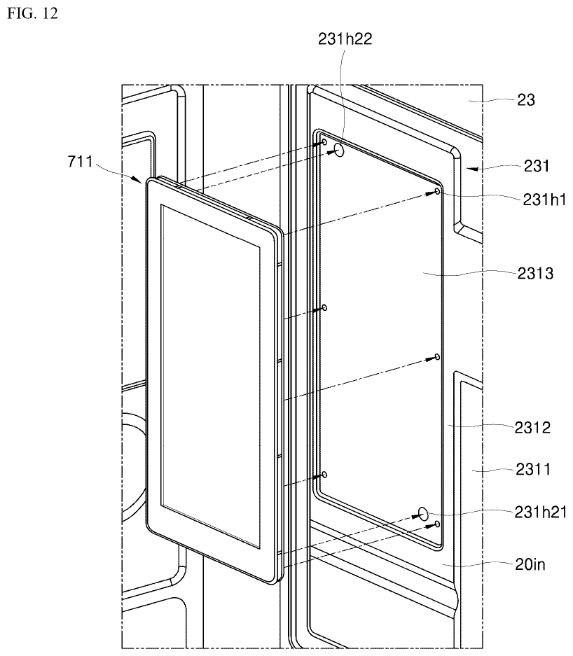

The preliminary fastening process of the lighting device 71 using the first fastening portion and the final fastening process of the lighting device 71 using the second fastening portion will be described later with reference to FIGS. 12 to 17.

In one example, the front cover 711 is coupled to the front side of the diffusion plate 712 and serves to protect the diffusion plate 712 in a state in which the diffusion plate 712 may effectively illuminate the washing space 21 of the tub 20.

The front cover 711 may include a cover body 7111 formed in a frame shape in which an open area 711a is formed at a central inner side such that the diffusion plate 712 may effectively illuminate the washing space 21 of the tub 20.

The open area 711a at the central inner side of the cover body 711 may define an area siz of the exposed surface 712a1 formed on the diffusion plate 712, and accordingly, an area size of the light-emitting surface 71a of the lighting device 71 may be defined.

That is, inner edges of the cover body 7111 having the frame shape define the upper edge 71a1, the lower edge 71a2, the left end 71a3, and the right end 71a4 of the light-emitting surface 71a.

As described above, the cover body 7111 may be formed on the non-exposed surface of the front surface 712a of the plate body 7121 and may be coupled to the diffusion plate 712 in the surface contact state with the stepped surface concavely defined rearwards.

In one example, the cover body 7111 is disposed in a state of being exposed to the washing space 21 of the tub 20.

Therefore, the cover body 7111 may be manufactured through press processing of a metal material having predetermined heat resistance and corrosion resistance corresponding to an environment of the washing space 21.

Illustratively, the cover body 7111 may be made of a stainless steel-based material.

Furthermore, the cover body 7111 may be made of the same material as the tub 20.

Accordingly, a sense of unity between the cover body 7111 and the tub 20 may be formed, and aesthetics perceived by the user may be improved.

In one example, the front cover 711 may include a plurality of fastening tabs 7112 integrally formed with the cover body 7111.

The fastening tab 7112 may be integrally connected to the outer edge of the front cover 711 and may extend rearwards linearly.

A rear end of the fastening tab 7112 may extend rearwards beyond the plate body 7121 of the diffusion plate 712.

The fastening tab 7112 may be coupled to the plate body 7121 of the diffusion plate 712 while being plastically deformed.

The edge groove 7125 into which each fastening tab 7112 is coupled while being plastically deformed may be defined in an outer edge surface of the plate body 7121 of the diffusion plate 712.

In one example, the gasket 717 serves to seal a space between the rear cover 715 forming the rear surface of the lighting device 71 and the inner surface of the rear wall 23 of the tub 20.

To this end, the gasket 717 includes a gasket body 7171 coupled to the rear surface of the rear cover 715.

In a similar manner to the front cover 711, the gasket body 7171 may be coupled to the rear surface of the rear cover 715 in a frame shape.

In this regard, an inner edge of the gasket body 7171 may extend up to a position of the screw hole 231h1 defined in the rear wall 23 of the tub 20.

Accordingly, a screw hole 7171a may be defined in the gasket body 7171 corresponding to the screw hole 231a of the tub 20.

In addition, the inner edge of the gasket body 7171 may extend up to a position of the first through hole 231h21 and a position of the second through hole 231h22 defined in the rear wall 23 of the tub 20.

Accordingly, a protrusion hole 7171b may be defined in the gasket body 7171 corresponding to the first through hole 231h21 and the second through hole 231h22 of the tub 20.

In one example, the gasket 717 may also serve to seal the accommodating space defined insid the diffusion plate 712.

To this end, as shown in FIG. 11, an outer edge of the gasket 717 may extend beyond the accommodating space-defining rib 7122 of the diffusion plate 712 up to the rear surface of the plate body 7121 of the diffusion plate 712.

Accordingly, a gap defined between the accommodating space-defining rib 7122 of the diffusion plate 712 and the reinforcing rib 7152 of the rear cover 715 may be closed.

In one example, as shown, multiple embossed protrusions 7172 protruding from the gasket body 7171 may be disposed on a rear surface of the gasket 717 in contact with the inner surface 20in of the rear wall 23 of the tub 20 to increase sealing performance.

In one example, the gasket 717 may be formed by overmolding an elastic material having a predetermined elasticity onto the rear cover 715 and the diffusion plate 712 constituting a rear outer surface 20out of the lighting device 71.

Accordingly, the sealing performance and airtightness of the lighting device 71 through the gasket 717 may be improved, but a manufacturing process of the lighting device 71 may be simplified.

As described above, in a state in which the front cover 711, the diffusion plate 712, the light source 714, and the rear cover 715 have been completely assembled, the gasket 717 is formed through the overmolding, so that assembly of each modularized lighting device 71 may be completed.

### Fastening Process of Lighting Device

Hereinafter, referring to FIGS. 12 to 17, a process in which the lighting device 71 according to an embodiment of the present disclosure is fastened to the rear wall 23 of the tub 20 will be described.

As described above, each lighting device 71 according to an embodiment of the present disclosure is fastened to the inner surface 20in of the rear wall 23 of the tub 20 in the state in which the assembly has been completed in the modularized state.

In this regard, as described above, each lighting device 71 may be preliminarily-fastened by the first fastening portion in the state in which the assembly has been completed in the modularized state.

First, as shown in FIG. 12, each lighting device 71 in the modularized state may be entirely introduced into the inner washing space 21 of the tub 20 through the open front surface of the tub 20.

The lighting device 71 introduced into the washing space 21 of the tub 20 may be horizontally moved rearwards while being aligned with the rear wall 23 of the tub 20.

In this regard, a coupling direction of the lighting device 71 may be aligned such that the first connection protrusion 7155 of the rear cover 715 is positioned at the position of the first through hole 231h21 of the tub 20 and the second connection protrusion 7156 of the rear cover 715 is positioned at the position of the second through hole 231h22.

That is, the fastening position of the lighting device 71 may be guided by the first through hole 231h21 corresponding to the first connection protrusion 7155 and the second through hole 231h22 corresponding to the second connection protrusion 7156.

As described above, the lighting device 71 may be horizontally moved toward the rear wall 23 of the tub 20 in the state of being aligned such that the first connection protrusion 7155 is at a position insertable into the first through hole 231h21 and the second connection protrusion 7156 is at a position insertable into the second through hole 231h22.

As the lighting device 71 comes into close contact with the rear wall 23 of the tub 20, a rear end of the first connection protrusion 7155 passes through the first through hole 231h21, and a rear end of the second connection protrusion 7156 passes through the second through hole 231h22.

As described above, when the rear end of the first connection protrusion 7155 passes through the first through hole 231h21, engagement between the hook protrusion 7155b of the first connection protrusion 7155 and the first through hole 231h21 may be formed.

In addition, when the rear end of the second connection protrusion 7156 extends through the second through hole 231h22, engagement between a hook protrusion of the second connection protrusion 7156 and the second through hole 231h22 may be formed.

Accordingly, by such an engagement, a mounted state in which the lighting device 71 is prevented from deviating from a correct position may be achieved without a separate additional coupling.

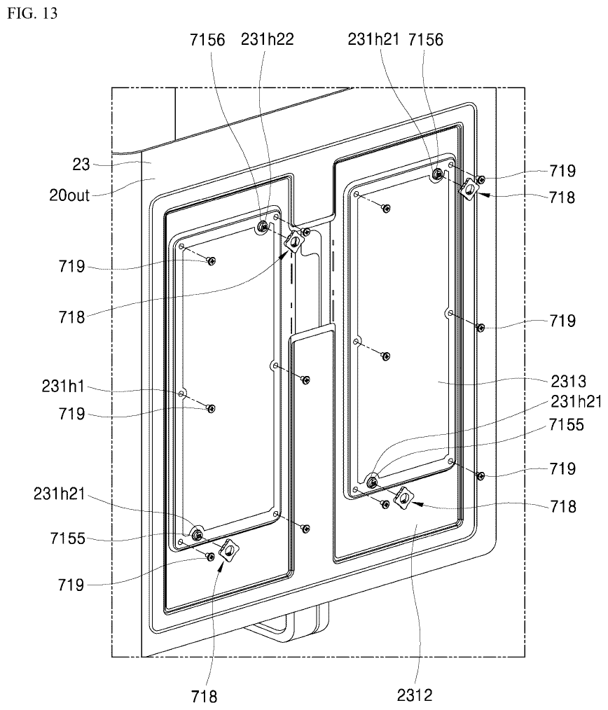

As shown in FIG. 13, in a state in which the rear end of the first connection protrusion 7155 has extended through the first through hole 231h21 and the rear end of the second connection protrusion 7156 has extended through the second through hole 231h22, a pair of holders 718 may be coupled to the rear end of the first connection protrusion 7155 and the rear end of the second connection protrusion 7156, respectively.

As described above, the fastening between the first connection protrusion 7155 and the holder 718 may be completed through simple insertion coupling and then rotation by the hook protrusion 7155b formed at the rear end of the first connection protrusion 7155 and the spiral locking protrusion 7183 of the holder 718.

Similarly, the fastening between the second connection protrusion 7156 and the holder 718 may be completed through simple insertion coupling and then rotation by the hook protrusion formed at the rear end of the second connection protrusion 7156 and the spiral locking protrusion 7183 of the holder 718.

When the fastening between the first connection protrusion 7155 and the holder 718 and the fastening between the second connection protrusion 7156 and the holder 718 are completed as described above, the preliminary fastening of the lighting device 71 to the rear wall 23 of the tub 20 may be completed.

As such, after the preliminary fastening of the lighting device 71 is completed, the final fastening of the lighting device 71 to the rear wall 23 of the tub 20 may be completed from the rear outside of the tub 20.

As described above, the final fastening of the lighting device 71 may be performed through τ total of six screw bolts 719.

Each screw bolt 719 may be introduced into the tub 20 from the outer surface 20out of the rear wall 23 of the tub 20 through the individual screw hole 231h1 of the tub 20.

As described above, the screw bolt 719 introduced into the tub 20 may extend through the screw hole 7171a defined in the gasket 717 and the screw hole 7153 defined in the rear cover 715 and may be screwed to the fastening nut 716 disposed in the diffusion plate 712.

When the fastening of the total of six screw bolts 719 is completed, the final fastening of the lighting device 71 may be completed.

In one example, as shown, front and rear sides of the lighting device 71 have a vertically symmetrical and horizontally symmetrical shape.

Therefore, the lighting device 71 may be assembled while being turned upside down, that is, may be misassembled.

To prevent the lighting device 71 from being misassembled, first, the first connection protrusion 7155 and the second connection protrusion 7156, which constitute the first fastening portion and are disposed on the rear surface of the rear cover 715, may be arranged at positions asymmetrical to each other in the up-down direction (U-D direction).

In addition, to prevent the lighting device 71 from being misassembled, the first connection protrusion 7155 and the second connection protrusion 7156, which are disposed on the rear surface of the rear cover 715, may be arranged at positions asymmetrical to each other in the left-right direction (Le-Ri direction).

Correspondingly, the first through hole 231h21 and the second through hole 231h22 may be defined at positions asymmetrical to each other in the up-down direction (U-D direction) or the left-right direction (Le-Ri direction).

As described above, as the first connection protrusion 7155 and the second connection protrusion 7156 are arranged at the positions asymmetrical to each other in the up-down direction or the left-right direction, and the first through hole 231h21 and the second through hole 231h22 are defined at the positions asymmetrical to each other in the up-down direction or the left-right direction, a state in which the first connection protrusion 7155 is not able to be inserted into the second through hole 231h22 and a state in which the second connection protrusion 7156 is not able to be inserted into the first through hole 231h21, that is, a state in which the preliminary fastening is not allowed may be achieved.

Furthermore, to prevent the lighting device 71 from being misassembled, a pair of screw holes 231h1 through which at least a pair among the plurality of screw bolts 719 constituting the second fastening portion extend may be defined at positions asymmetrical to each other in the up-down direction (U-D direction).

Alternatively, the pair of screw holes 231h1 through which at least a pair among the plurality of screw bolts 719 constituting the second fastening portion extend may be defined at positions asymmetrical to each other in the left-right direction (Le-Ri direction).

Illustratively, the pair of screw holes 231h1 may be screw holes 231h1 defined at intermediate positions in the up-down direction (U-D direction).

Because the screw holes 231h1 defined at the intermediate positions are defined at the positions asymmetrical to each other in the up-down direction (U-D direction) or at the positions asymmetrical to each other in the left-right direction (Le-Ri direction), the screw bolts 719 are not able to extend through the pair of screw holes 231h1 at positions other than correct positions.

Accordingly, a state in which the final fastening of the lighting device 71 is not allowed when the lighting device 71 is out of the correct position may be achieved.

In one example, as a means for guiding a placement position and an arrangement position of each modularized lighting device 71, the rear wall 23 of the tub 20 may include the formed area 231 recessed frontwards or rearwards.

In the illustrated embodiment, the configuration in which the formed area 231 is formed in bead forming manner is shown as an example. However, the present disclosure may not be limited thereto, and the formed area 231 may be formed through other press processes such as embossing and drawing.

In more detail, as shown in FIGS. 12 and 13, the formed area 231 may include the first formed area 2311 that is concavely recessed rearwards through the primary bead forming.

The water guide defining the second supply flow path 463 may be disposed so as to be at least partially inserted into the first formed area 2311 in a surface contact state.

The water guide defining the second supply flow path 463 may extend along the up-down direction (U-D direction) in a form of dividing the first formed area 2311 into left and right sides along the left-right direction (Le-Ri direction).

In one example, the formed area 231 may further include the second formed area 2312 formed in the inner area of the first formed area 2311.

The second formed area 2312 may be formed in the inner area of the first formed area 2311.

The second formed area 2312 may be formed through partial secondary forming of a formed surface of the first formed area 2311.

In this regard, a pair of second formed areas 2312 may be equipped to have symmetrical positions and symmetrical shapes around the water guide with the water guide defining the second supply flow path 463 interposed therebetween.

However, a forming direction of the second formed area 2312 may be opposite to a forming direction of the first formed area 2311.

That is, the second formed area 2312 may convexly protrude frontwards from the formed surface of the first formed area 2311.

In this regard, a formation depth of the second formed area 2312 may be slightly greater than or equal to a formation depth of the first formed area 2311.

Such determination of the protruding direction and the formation depth of the second formed area 2312 is made in consideration of the lighting device-mounted formed area 2313 defined inside the second formed area 2312.

That is, as shown, the formed area 231 may further include the lighting device-mounted formed area 2313 defined in an inner area of the second formed area 2312.

The lighting device-mounted formed area 2313 may be defined in the inner area of the first formed area 2311 and the inner area of the second formed area 2312.

However, the shown embodiment is merely illustrative.

That is, the lighting device-mounted formed area 2313 may be defined in the inner area of the first formed area 2311 without the presence of the second formed area 2312, or only the lighting device-mounted formed area 2313 may be defined in the rear wall 23 of the tub 20 without forming the first formed area 2311 and the second formed area 2312.

In this regard, when only the single formed area 231 is defined in the rear wall 23 of the tub 20 and the lighting device 71 is coupled to the single formed area 231, the formed area 231 to which the lighting device 71 is coupled may be referred to irrespective of whether it is named as a first formed area, a second formed area, or a lighting device mounting formed area.

Furthermore, the lighting device 71 may be coupled to the rear wall 23 of the tub 20 without forming the first formed area 2311, the second formed area 2312, and the lighting device-mounted formed area 2313.

A description will be made based on the shown embodiment although the present disclosure is not limited thereto.

The lighting device-mounted formed area 2313 may be defined through partial forming of a formed surface of the second formed area 2312, and the lighting device 71 may be disposed to be at least partially inserted into the lighting device-mounted formed area 2313.

In a similar manner to the second formed area 2312, a pair of lighting device-mounted formed areas 2313 may be equipped to have symmetrical positions and symmetrical shapes around the water guide with the water guide defining the second supply flow path 463 interposed therebetween.

In addition, a forming direction of the lighting device-mounted formed area 2313 may be opposite to the forming direction of the second formed area 2312.

That is, the lighting device-mounted formed area 2313 may be concavely recessed rearwards from the formed surface of the second formed area 2312.

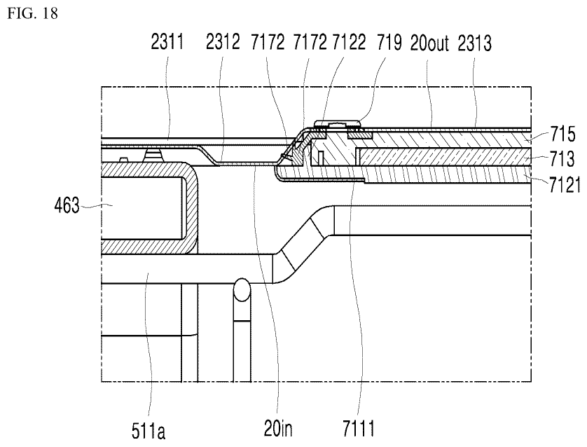

In this regard, as shown in FIGS. 18 to 20, a formation depth of the lighting device-mounted formed area 2313 may be greater than the formation depth of the first formed area 2311.

This is in consideration of the width or thickness in the front-rear direction (F-R direction) of the lighting device 71 coupled to the inside of the lighting device-mounted formed area 2313.

As described above, by defining the lighting device-mounted formed area 2313, which is concavely recessed rearwards, inside the second formed area 2312, which protrudes frontwards, the width in the front-rear direction (F-R direction) of the tub 20 may be effectively prevented from increasing.

In one example, as the lighting device 71 is at least partially inserted, a maximum width in the left-right direction (Le-Ri direction) of the lighting device-mounted formed area 2313 may be smaller than or equal to a maximum width in the left-right direction (Le-Ri direction) of the lighting device 71.

In addition, for the same reason, a maximum width in the up-down direction (U-D direction) of the lighting device-mounted formed area 2313 may be smaller than or equal to a maximum width in the up-down direction (U-D direction) of the lighting device 71.

In addition, for the same reason, the formation depth of the lighting device-mounted formed area 2313 may be smaller than or equal to the width or thickness in the front-rear direction (F-R direction) of the lighting device 71.

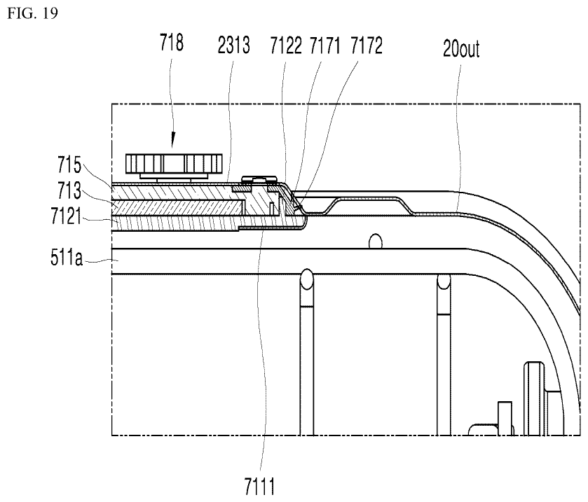

FIGS. 18 and 19 show a configuration in which the lighting device 71 is partially inserted into and accommodated in the lighting device-mounted formed area 2313 according to a first embodiment of the present disclosure.

As the lighting device 71 is partially accommodated in the lighting device-mounted formed area 2313, the maximum width in the left-right direction (Le-Ri direction) of the lighting device-mounted formed area 2313 may be smaller than the maximum width in the left-right direction (Le-Ri direction) of the lighting device 71.

In addition, the maximum width in the up-down direction (U-D direction) of the lighting device-mounted formed area 2313 may be smaller than the maximum width in the up-down direction (U-D direction) of the lighting device 71.

In addition, the formation depth of the lighting device-mounted formed area 2313 may be smaller than a thickness in the front-rear direction (F-R direction) of the lighting device 71.

In this regard, when the lighting device 71 excessively protrudes from the lighting device-mounted formed area 2313, there is a risk of colliding with the lower rack 51 or the upper rack 52 disposed ahead.

To prevent such a collision, portions of the lighting device 71 protruding from the formed surface of the second formed area 2312 may be limited to the plate body 7121 of the diffusion plate 712 and the cover body 7111 of the front cover 711.

That is, a protruding height at which the lighting device 71 protrudes beyond the formed surface of the second formed area 2312 may correspond to a thickness of the plate body 7121 of the diffusion plate 712.

As described above, because the lighting device 71 is partially inserted into the lighting device-mounted formed area 2313 and the portion thereof protruding from the formed surface of the second formed area 2312 is present, the light-emitting surface 71a may be formed at a position protruding from the formed surface of the second formed area 2312.

Light is dispersed through the light-emitting surface 71a in the up-down direction (U-D direction) and the left-right direction (Le-Ri direction) based on the lighting device 71, so that a lighting effect may be maximized.

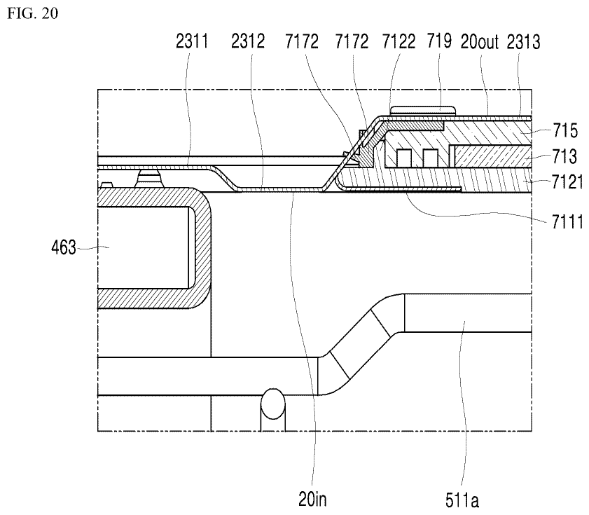

FIG. 20 shows a configuration in which the lighting device 71 is entirely inserted into and accommodated in the lighting device-mounted formed area 2313 according to a second embodiment of the present disclosure.

As the lighting device 71 is entirely accommodated in the lighting device-mounted formed area 2313, the maximum width in the left-right direction (Le-Ri direction) of the lighting device-mounted formed area 2313 may be greater than or equal to the maximum width in the left-right direction (Le-Ri direction) of the lighting device 71.

In addition, the maximum width in the up-down direction (U-D direction) of the lighting device-mounted formed area 2313 may be greater than or equal to the maximum width in the up-down direction (U-D direction) of the lighting device 71.

In addition, the formation depth of the lighting device-mounted formed area 2313 may be greater than or equal to the width in the front-rear direction (F-R direction) or the horizontal direction of the lighting device 71.

As described above, as the lighting device 71 is disposed to be entirely inserted into the lighting device-mounted formed area 2313, the portion of the lighting device 71 protruding from the formed surface of the second formed area 2312 is not present.

Accordingly, a possibility that the upper rack 52 and the lower rack 51 collide with the light-emitting surface 71a of the lighting device 71 is significantly reduced.

In addition, the dishes accommodated in the upper rack 52 and the lower rack 51 may be prevented from coming into contact with or colliding with the light-emitting surface 71a of the lighting device 71 during the washing cycle and the rinsing cycle.

In addition, because a step is not formed between the lighting device 71 and the formed surface of the second formed area 2312, a phenomenon in which food waste or the like is stuck between the lighting device 71 and the formed surface of the second formed area 2312 may be prevented and minimized.

Although the embodiments of the present disclosure have been described above in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

1. A dishwasher comprising:
a tub defining therein a washing space having an open front surface; and
a lighting device having a light-emitting surface for irradiating light toward the washing space, and disposed inside the tub,
wherein the lighting device is preliminarily-fastened to an inner surface of the tub using a first fastening portion and then is finally-fastened thereto using a second fastening portion.

2. The dishwasher of claim 1, wherein the lighting device is preliminarily-fastened and finally-fastened to the inner surface of the tub.

3. The dishwasher of claim 1, wherein the first fastening portion includes a connection protrusion protruding rearwards from a rear surface of the lighting device and guiding a fastening position of the lighting device,
wherein the tub includes a through hole defined therethrough to allow the connection protrusion to be inserted and coupled thereinto.

4. The dishwasher of claim 3, wherein the connection protrusion includes a first connection protrusion and a second connection protrusion arranged to be spaced apart from each other at different positions,
wherein at least one of the first connection protrusion and the second connection protrusion has a passage allowing an inner space of the lighting device and an external space of the tub to be in communication with each other.

5. The dishwasher of claim 4, wherein the lighting device includes:
a light source element configured to generate light; and
a circuit board where the light source element and a connector configured to receive power from an external source are mounted,
wherein the connector or a harness electrically connected to the connector is inserted into the passage.

6. The dishwasher of claim 4, wherein the first connection protrusion and the second connection protrusion are arranged at positions spaced apart from each other along an up-down direction on the rear surface of the lighting device.

7. The dishwasher of claim 4, wherein the first connection protrusion and the second connection protrusion are arranged at positions spaced apart from each other along a diagonal direction on the rear surface of the lighting device.

8. The dishwasher of claim 6, wherein the first connection protrusion and the second connection protrusion are arranged at positions asymmetrical to each other in the up-down direction or in a left-right direction.

9. The dishwasher of claim 3, wherein the connection protrusion includes:
a body having one end integrally connected to the rear surface of the lighting device and a remaining end extending to the outside of the tub through the through hole; and
a protrusion formed to protrude radially outwards from an outer circumferential surface of the remaining end of the body.

10. The dishwasher of claim 9, wherein a maximum outer diameter of the protrusion is greater than or equal to a diameter of the through hole.

11. The dishwasher of claim 9, wherein an outer diameter of the body is smaller than a diameter of the through hole.

12. The dishwasher of claim 9, wherein the first fastening portion further includes a holder disposed outside the tub and coupled to the protrusion in a stopped manner.

13. The dishwasher of claim 12, wherein the holder includes:
a hollow allowing the body of the connection protrusion to be inserted and coupled thereinto; and
a locking protrusion integrally formed with an inner circumferential surface of the hollow and coupled to the protrusion in the stopped manner,
wherein the locking protrusion extends spirally along the inner circumferential surface of the hollow.

14. The dishwasher of claim 3, wherein the second fastening portion includes a plurality of screw bolts extending through the tub from outside toward inside of the tub and screwed to the lighting device,
wherein the tub includes a plurality of screw holes defined through the tub such that the plurality of screw bolts extend therethrough, respectively,
wherein at least one pair among the plurality of screw holes are arranged at positions asymmetrical to each other in a left-right direction or at positions asymmetrical to each other in an up-down direction.

15. The dishwasher of claim 3, wherein the lighting device includes a gasket sealing a space between the rear surface of the lighting device and the inner surface of the tub.

16. The dishwasher of claim 15, wherein the gasket is formed by molding an elastic material having a predetermined elasticity onto an outer surface of the lighting device.

17. The dishwasher of claim 1, further comprising a dish rack configured to store dishes therein, and including a plurality of racks disposed in the washing space so as to be extendable and retractable,
wherein a lower edge of the light-emitting surface is positioned lower than an upper end of a lower rack positioned at a lowest position among the plurality of racks.

18. The dishwasher of claim 17, wherein an upper edge of the light-emitting surface is positioned higher than an upper end of an upper rack positioned above the lower rack among the plurality of racks.

19. The dishwasher of claim 17, wherein a bumper disposed to protrude rearwards from a rear end of the lower rack is formed on a rear side of the lower rack,
wherein a protrusion height of the bumper from the rear end of the lower rack is greater than a protrusion height of the lighting device from the inner surface of the tub.

20. The dishwasher of claim 19, wherein the bumper is positioned lower than the lighting device.
